(19) United States
(12) Patent Application Publication
(10) Pub. No.: US 2017/0364239 A1
(43) Pub. Date: Dec. 21, 2017

(54) APPLICATION ICON CUSTOMIZATION

(71) Applicant: iDevices, LLC, Avon, CT (US)

(72) Inventors: Daniel Gould, East Hampton, CT (US); Matthew Harrison, New Hartford, CT (US)

(21) Appl. No.: 15/625,663

(22) Filed: Jun. 16, 2017

Related U.S. Application Data
(60) Provisional application No. 62/396,204, filed on Sep. 18, 2016.
(60) Provisional application No. 62/352,009, filed on Jun. 19, 2016.

(51) Int. Cl. G06F 3/0481; G06F 3/0484; G06F 3/0488

(52) U.S. Cl. CPC G06F 3/04817; G06F 3/04886; G06F 3/04845; G06F 3/04847

(57) ABSTRACT

A computer application or program for controlling devices located remotely from a user. The application is adapted to permit a user to utilize and input into the application custom images or icons of a device, such as by using a camera of the computerized device upon which the application is installed. The application may optionally be adapted to permit a user to customize images or icons representing locations, areas, buildings and room in which a controlled device is located. In related methods, a user can customize an icon or image in a computer application for depicting one or more locations, areas, buildings, rooms and devices by inputting into the application a custom image or icon created or selected by the user.

### CROSS-REFERENCE TO RELATED PATENT APPLICATION

This patent application claims benefit under 35 U.S.C. §119 to U.S. Provisional Patent Application Ser. No. 62/352,009, filed Jun. 19, 2016, entitled “APPLICATION ICON CUSTOMIZATION,” and to U.S. Provisional Patent Application Ser. No. 62/396,204, filed Sep. 18, 2016, entitled “APPLICATION ICON CUSTOMIZATION,” each of which is hereby expressly incorporated by reference in its entirety as part of the present disclosure.

### FIELD OF THE DISCLOSURE

The present disclosure generally relates to customization of icons in a computer program or application that remotely controls one or more devices located at a remote or other location. More specifically, the present disclosure relates to computer programs or applications that enable a user to insert or substitute icons of a user's choice, such as, but not limited to, images or photographs of the locations, areas and/or objects that may be remotely controlled by or via the computer program or application.

### BACKGROUND INFORMATION

Computer programs and applications permit control of devices that are at locations that are remotely located from the location of a user. A user interfaces with the computer program or application on a computerized device, and command instructions are delivered to the remote devices over a network, such as, for example, the Internet. Within these applications, a particular device to be controlled may be identified, such as by a textual description or an icon. For example, a thermostat may be represented by an icon or image of a thermostat.

### SUMMARY

Previously-known icons or images are typically generic representations of the device to be controlled. They may be, for example, an image chosen by the application provider from “stock” images or icons. Thus, the images a user sees in the application are not a true representation of the device. Moreover, where the application controls more than one of a type of device, for example, multiple thermostats or multiple lamps, which particular of those devices is which is not identified in the application. The user must rely on memory, or guess, which may result in the wrong device being controlled.

It is an object of at least some embodiments to address one or more of the above-described deficiencies of known remote control programs and applications.

The inventors have discovered that it would be advantageous to provide a computer program or application that remotely controls devices to have the capability to allow a user to customize the image or icon representing the device or function to be controlled. In some embodiments, the customized image or icon helps the user distinguish between controls that correspond to the device or function to be controlled and controls that correspond to other devices or functions, thereby increasing the likelihood that the user will access the proper controls as opposed to the wrong controls. In some embodiments, the user can enter or upload into the application an image or icon of choice. In some such embodiments, the image or icon can be a photograph of the actual device to be controlled. The photograph may be a previously-taken photograph that can be accessed by the application, such as from the memory of the computer on which the application is installed or from a remote memory, e.g., the Cloud. In other embodiments, the photograph can be obtained “live” by a camera or other imager present in or connected to the computer on which the application is installed. That is, for example, the photograph can be taken by the user and directly inserted to the application as the device's icon.

It should be understood by those of ordinary skill in the art that the computer application or program may take the form of any suitable computer program, application, or computer readable medium (e.g., a non-transitory computer-readable medium) using any suitable language or protocol. The computer application may include, as should be recognized, any suitable interface to interface with a user and receive inputs from the user to provide instructions for the control of the remote device. Such exemplary input mechanisms include, but are not limited to, keyboard input, touchscreen input, and voice input. In some embodiments, the user interface is adapted to provide information to the user as to the identity and/or status of the device to be controlled. Exemplary interfaces include, but are not limited to, visual (e.g., a view screen or monitor) and auditory (e.g., voice) delivery of such information.

It should also be understood that the computerized device may be any suitable device or devices adapted to store, read and/or execute the program. The computer system may include, for example, without limitation, a mobile device, such as a mobile phone or smart phone, a desktop computer, a mainframe or server-based computer system, or Cloud-based computer system.

It should further be understood that that the computerized device may transmit to and/or receive from the remotely-controlled device information and/or instructions by any suitable means, including wireless and wired communications and networks, and any combinations thereof. Such may include, by non-limiting example, WiFi, RF (radio frequency), Bluetooth, Bluetooth Low Energy, infrared, Internet, cellular, and Ethernet technologies and protocols.

In one aspect, a non-transitory computer-readable medium has computer-readable instructions stored thereon that, if executed by a computer system, result in a method comprising: displaying, on a user interface of the computer system, an image or icon representing (i) a device adapted to be controlled by the computer system that is separate from the device or (ii) a zone, location, area, building or room in which said device is located; and substituting, for said at least one image or icon, an image or icon selected or created by a user.

In at least some embodiments, the method further comprises displaying, on the user interface, the user-selected or created image or icon to represent said device, zone, location, area, building or room.

In at least some embodiments, the substituting step includes substituting an image received from a camera or imager operatively connected to the computer system.

In at least some embodiments, the substituting step includes substituting an image or icon received from (1) the computer system or (2) a memory remote from said computer system.

In at least some embodiments, the method further comprising accepting, from the user interface, an instruction from a user to substitute, for said at least one image or icon, an image or icon selected or created by a user.

In at least some embodiments, the user interface is one or more of a keyboard, a touchscreen or a voice input.

In another aspect, a method comprises: displaying, on a user interface of a computer system, an image or icon representing a device adapted to be controlled by the computer system that is separate from the device, or a zone, location, area, building or room in which said device is located; and substituting, for said at least one image or icon, an image or icon selected or created by a user.

In at least some embodiments, the method further includes displaying, on the user interface, the user-selected or created image or icon to represent said device, zone, location, area, building or room.

In at least some embodiments, the method further includes receiving an image from a camera or imager operatively connected to the computer system, and wherein the substituting step includes substituting said image from said camera or imager.

In at least some embodiments, the substituting step includes substituting an image or icon received from: (1) the computer system or (2) a memory remote from said computer system.

In at least some embodiments, the method further includes accepting, from the user interface, an instruction from a user to substitute, for said at least one image or icon, an image or icon selected or created by a user.

In at least some embodiments, the user interface is one or more of a keyboard, a touchscreen or a voice input.

In another aspect, apparatus comprises a computer system configured to: display, on a user interface, an image or icon representing a device adapted to be controlled by the computer system that is separate from the device, or a zone, location, area, building or room in which said device is located; and substitute, for said at least one image or icon, an image or icon selected or created by a user.

In at least some embodiments, the computer system is further configured to display, on the user interface, the user-selected or created image or icon to represent said device, zone, location, area, building or room.

In at least some embodiments, the apparatus is configured to substitute, for said at least one image or icon, an image or icon selected or created by a user, by substituting an image received from a camera or imager operatively connected to the computer system.

In at least some embodiments, the apparatus is configured to substitute, for said at least one image or icon, an image or icon selected or created by a user, by substituting an image or icon received from (1) the computer system or (2) a memory remote from said computer system.

In at least some embodiments, the computer system is further configured to accept, from the user interface, an instruction from a user to substitute, for said at least one image or icon, an image or icon selected or created by a user.

In at least some embodiments, the user interface is one or more of a keyboard, a touchscreen or a voice input.

In another aspect, a method comprises: receiving, in a computing device, an indication that a user has chosen to define a custom icon associated with: (a) a device to be controlled that is separate from the computing device and/or (b) a zone, a building, a location and/or a room in which said device is located or will be located; receiving, in a computing device, information from the user defining the custom icon, at least in part; identifying, by a computing device, predetermined information associated with a view in a user interface configured for use in control of the device, which is separate from a computing device configured to display the view; generating, by a computing device, the view; and displaying, by the computing device configured to display the view, the view, which includes: (i) visually perceptible information based at least in part on the predetermined information and (ii) visually perceptible information that is associated with: (a) the device to be controlled and/or (b) the zone, building, location and/or room, and based at least in part on the information from the user.

In another aspect, a non-transitory computer-readable medium has computer-readable instructions stored thereon that, if executed by a computer system, result in a method comprising: receiving, in a computing device, an indication that a user has chosen to define a custom icon associated with: (a) a device to be controlled that is separate from the computing device and/or (b) a zone, a building, a location and/or a room in which said device is located or will be located; receiving, in a computing device, information from the user defining the custom icon, at least in part; identifying, by a computing device, predetermined information associated with a view in a user interface configured for use in control of the device, which is separate from a computing device configured to display the view; generating, by a computing device, the view; and displaying, by the computing device configured to display the view, the view, which includes: (i) visually perceptible information based at least in part on the predetermined information and (ii) visually perceptible information that is associated with: (a) the device to be controlled and/or (b) the zone, building, location and/or room, and based at least in part on the information from the user.

In another aspect, a method comprises: receiving, in a computing device, information associated with a user or other entity; determining, by a computing device, a view that is to be generated and displayed in a user interface configured for use in control of a device that is separate from a computing device configured to display the view; identifying, by a computing device, predetermined information associated with the view; determining, by a computing device based at least in part on the information associated with the user or other entity, that the user or other entity has specified custom icon information associated with the device and/or a zone, a building, a location and/or a room in which said device is located or will be located; generating, by a computing device, the view; and displaying, by the computing device configured to display the view, the view, which includes: (i) visually perceptible information based at least in part on the predetermined information and (ii) visually perceptible information that is associated with: (a) the device to be controlled and/or (b) the zone, the building, the location and/or the room, and based at least in part on the custom icon information specified by the user.

In another aspect, a non-transitory computer-readable medium has computer-readable instructions stored thereon that, if executed by a computer system, result in a method comprising: receiving, in a computing device, information associated with a user or other entity; determining, by a computing device, a view that is to be generated and displayed in a user interface configured for use in control of a device that is separate from a computing device configured to display the view; identifying, by a computing device, predetermined information associated with the view; determining, by a computing device based at least in part on the information associated with the user or other entity, that the user or other entity has specified custom icon information associated with the device and/or a zone, a building, a location and/or a room in which said device is located or will be located; generating, by a computing device, the view; and displaying, by the computing device configured to display the view, the view, which includes: (i) visually perceptible information based at least in part on the predetermined information and (ii) visually perceptible information that is associated with: (a) the device to be controlled and/or (b) the zone, the building, the location and/or the room, and based at least in part on the custom icon information specified by the user.

This Summary is not exhaustive of the scope of the present aspects and embodiments. Moreover, this Summary is not intended to be limiting and should not be interpreted in that manner. Thus, while certain aspects and embodiments have been presented and/or outlined in this Summary, it should be understood that the present aspects and embodiments are not limited to the aspects and embodiments in this Summary. Indeed, other aspects and embodiments, which may be similar to and/or different from, the aspects and embodiments presented in this Summary, will be apparent from the description, illustrations and/or claims, which follow.

It should be understood that any aspects and embodiments that are described in this Summary and do not appear in the claims that follow are preserved for presentation in one or more continuation patent applications.

It should also be understood that any aspects and embodiments that are not described in this Summary and do not appear in the claims that follow are also preserved for presentation in one or more continuation patent applications.

Although various features, attributes and advantages have been described in this Summary and/or are apparent in light thereof, it should be understood that such features, attributes and advantages are not required in all aspects and embodiments, and except where stated otherwise, need not be present in all aspects and the embodiments.

Other objects and/or advantages should also be apparent in view of the following detailed description of aspects and embodiments and the accompanying drawings. It should be understood, however, that any such objects and/or advantages are not required in all aspects and embodiments.

### BRIEF DESCRIPTION OF THE DRAWINGS

The foregoing features of the disclosure will be apparent from the following Detailed Description, taken in connection with the accompanying drawings, in which:

FIG. 1 is a view of a screen of a user interface of an embodiment of a computer application for controlling a remote device;

FIG. 2 is a view of another screen of the user interface of FIG. 1;

FIG. 3 is a view of another screen of the user interface of FIG. 1;

FIG. 4 is a view of the screen shown in FIG. 1 after it has been modified;

FIG. 5 is a view of the screen shown in FIG. 1;

FIG. 6 is a view of another screen of the user interface of FIG. 1;

FIG. 7 is a view of another screen of the user interface of FIG. 1;

FIG. 8 is a view of another screen of the user interface of FIG. 1;

FIG. 9 is a view of another screen of the user interface of FIG. 1;

FIG. 10 is a view of another screen of the user interface of FIG. 1;

FIG. 11 is a view of the screen shown in FIG. 9 after it has been modified;

FIG. 12 is a view of the screen shown in FIG. 1;

FIG. 13 is a view of another screen of the user interface of FIG. 1;

FIG. 14 is a view of another screen of the user interface of FIG. 1;

FIG. 15 is a view of another screen of the user interface of FIG. 1;

FIG. 16 is a view of another screen of the user interface of FIG. 1;

FIG. 17 is a view of the screen shown in FIG. 4;

FIG. 18 is a block diagram of a system in which one or more devices located at a remote or other location may be controlled via a computer program or application, in accordance with some embodiments;

FIG. 19 is a schematic diagram of a system that includes a power switching device, a corded device, and a IOT connected computing device, in accordance with some embodiments;

FIG. 20 is a schematic representation of a computing device displaying a view in a graphical user interface, in accordance with some embodiments;

FIG. 21 is a schematic representation of the computing device of FIG. 20 displaying another view in a graphical user interface, in accordance with some embodiments;

FIG. 22 is a schematic representation of the computing device of FIG. 20 displaying another view in a graphical user interface, in accordance with some embodiments;

FIG. 23 is a schematic representation of the computing device of FIG. 20 displaying another view in a graphical user interface, in accordance with some embodiments;

FIG. 24 is a schematic representation of the computing device of FIG. 20 displaying another view in a graphical user interface, in accordance with some embodiments;

FIG. 25 is a schematic representation of the computing device of FIG. 20 displaying another view in a graphical user interface, in accordance with some embodiments;

FIG. 26 is a schematic representation of the computing device of FIG. 20 displaying another view in a graphical user interface, in accordance with some embodiments;

FIG. 27 is a schematic representation of the computing device of FIG. 20 displaying another view in a graphical user interface, in accordance with some embodiments;

FIG. 28 is a schematic representation of the computing device of FIG. 20 displaying another view in a graphical user interface, in accordance with some embodiments;

FIG. 29 is a schematic representation of the computing device of FIG. 20 displaying another view in a graphical user interface, in accordance with some embodiments;

FIG. 30 is a schematic representation of the computing device of FIG. 20 displaying another view in a graphical user interface, in accordance with some embodiments;

FIG. 31 is a schematic representation of the computing device of FIG. 20 displaying another view in a graphical user interface, in accordance with some embodiments;

FIG. 32 is a schematic representation of the computing device of FIG. 20 displaying another view in a graphical user interface, in accordance with some embodiments;

FIG. 33 is a schematic representation of the computing device of FIG. 20 displaying another view in a graphical user interface, in accordance with some embodiments;

FIG. 34 is a schematic representation of the computing device of FIG. 20 displaying another view in a graphical user interface, in accordance with some embodiments;

FIG. 35 is a schematic representation of the computing device of FIG. 20 displaying another view in a graphical user interface, in accordance with some embodiments;

FIG. 36 is a schematic representation of the computing device of FIG. 20 displaying another view in a graphical user interface, in accordance with some embodiments;

FIG. 37 is a schematic representation of the computing device of FIG. 20 displaying another view in a graphical user interface, in accordance with some embodiments;

FIG. 38 is a schematic representation of the computing device of FIG. 20 displaying another view in a graphical user interface, in accordance with some embodiments;

FIG. 39 is a schematic representation of the computing device of FIG. 20 displaying another view in a graphical user interface, in accordance with some embodiments;

FIG. 40 is a schematic representation of the computing device of FIG. 20 displaying another view in a graphical user interface, in accordance with some embodiments;

FIG. 41 is a schematic representation of the computing device of FIG. 20 displaying another view in a graphical user interface, in accordance with some embodiments;

FIG. 42 is a schematic representation of the computing device of FIG. 20 displaying another view in a graphical user interface, in accordance with some embodiments;

FIG. 43 is a schematic representation of the computing device of FIG. 20 displaying another view in a graphical user interface, in accordance with some embodiments;

FIG. 44 is a schematic representation of the computing device of FIG. 20 displaying another view in a graphical user interface, in accordance with some embodiments;

FIG. 44 is a schematic representation of the computing device of FIG. 20 displaying another view in a graphical user interface, in accordance with some embodiments;

FIG. 45 is a schematic representation of the computing device of FIG. 20 displaying another view in a graphical user interface, in accordance with some embodiments;

FIG. 46 is a schematic representation of the computing device of FIG. 20 displaying another view in a graphical user interface, in accordance with some embodiments;

FIG. 47 is a schematic representation of the computing device of FIG. 20 displaying another view in a graphical user interface, in accordance with some embodiments;

FIG. 48 is a schematic representation of the computing device of FIG. 20 displaying another view in a graphical user interface, in accordance with some embodiments;

FIG. 49 is a schematic representation of the computing device of FIG. 20 displaying another view in a graphical user interface, in accordance with some embodiments;

FIG. 50 is a schematic representation of the computing device of FIG. 20 displaying another view in a graphical user interface, in accordance with some embodiments;

FIG. 51 is a schematic representation of the computing device of FIG. 20 displaying another view in a graphical user interface, in accordance with some embodiments;

FIG. 52 is a schematic representation of the computing device of FIG. 20 displaying another view in a graphical user interface, in accordance with some embodiments;

FIGS. 53-56 are schematic diagrams that collectively show a structure that may be used to store custom icons defined by or otherwise associated with a user or other entity, in accordance with some embodiments; and

FIG. 57 is a block diagram of an architecture according to some embodiments.

### DETAILED DESCRIPTION

At least some aspects and embodiments disclosed herein relate to methods, apparatus, systems and/or computer readable media for use in customization of one or more icons or images in one or more views generated by a computer program or application for remote or other control of one or more devices located at a remote or other location.

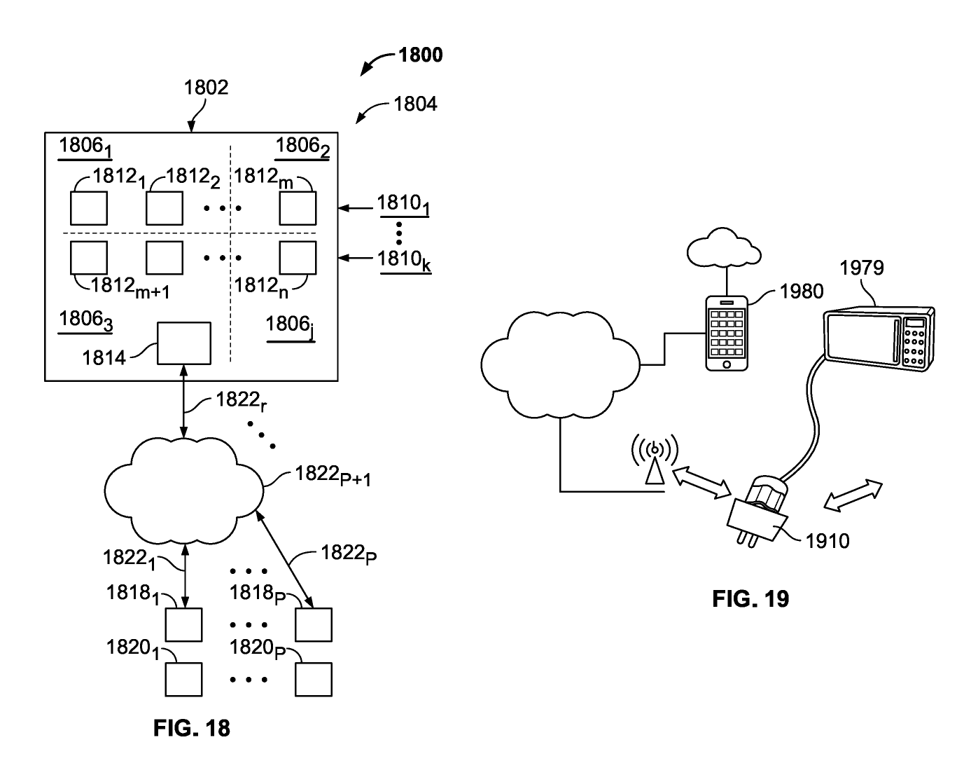

FIG. 18 is a block diagram of a system 1800 in which one or more devices located at a remote or other location may be controlled via a computer program or application, in accordance with some embodiments.

Referring to FIG. 18, in accordance with some embodiments, the system 1800 may include one or more buildings, e.g., building 1802, or other type(s) of site(s), which may be located in one or more locations, e.g., location 1804. Each building, e.g., 1802, may include one or more rooms, e.g., rooms 1806₁-1806ⱼ, which may be disposed or otherwise located on one or more floors, e.g., floors 1810₁-1810ₖ, and/or in one or more zones of the building. One or more devices to be controlled, e.g., devices 1812₁-1812ₙ, may be disposed or otherwise located in one or more of the rooms, floors and/or zones. One or more wireless access points, e.g., wireless access point 1814, or other communication device(s), may also be disposed or otherwise located in one or more of the rooms, floors and/or zones, and may be in wireless communication with, or otherwise coupled to, one or more of the device(s) to be controlled.

The system 1800 may further include one or more computing devices, e.g., computing devices 1818₁-1818ₚ, which may be operated by one or more users, e.g., users 1820₁-1820ₚ. In some embodiments, one or more of the computing device(s) may include one or more processors, one or more input devices and/or one or more output devices. In some embodiments, one or more processor(s) in a computing device executes one or more programs or applications to perform one or more tasks. As further described below, in some embodiments, one or more of the tasks may be associated with and/or include control of one or more of devices 1812₁-1812ₙ.

One or more of the computing device(s) may be coupled to one or more of the wireless access point(s) (or other communication device(s)), via one or more communication links, e.g., communication links 1822₁-1822ᵣ, and used in controlling one or more device(s) to be controlled. One or more of the communication links may define a network (or portion(s) thereof), e.g., a local area network or a wide area network, e.g., the Internet. In some embodiments, one or more of the computing device(s) may be located in, or sufficiently close to, a building, e.g., building 1802, or other type of site, to allow such one or more of the computing device(s) to communicate directly with one or more wireless access point(s) (or other communication device(s)) and/or to allow such one or more computing device(s) to communicate directly with one or more device(s) to be controlled.

Unless stated otherwise, the term “controlled” means “directly controlled” and/or “indirectly controlled.” Thus, a device that is to be controlled may be “directly controlled” and/or “indirectly controlled.”

FIG. 19 is a schematic diagram of a system 1900 that includes direct and indirect control of devices, in accordance with some embodiments.

Referring to FIG. 19, the system 1900 includes a power-switching device 1910, a corded device 1979, and an Internet of Things (IoT) connected computing device 1980.

The power-switching device 1910 is configured to be plugged into and receive electric power from an AC output. The corded device 1979 is plugged into the power-switching device 1910. The computing device 1980 is communicatively coupled to the power switching device 1910, which the computing device 1980 uses to control the operation (e.g., on/off) of the corded device 1979.

As such, the power-switching device 1910 and the corded device 1979 are each configured to be controlled, and controlled, by the computing device 1980. The power-switching device 1910 is directly controlled (by the computing device 1980). The corded device 1979 is indirectly controlled (by the computing device 1980 via the power-switching device 1910).

It should be understood, that control (direct and/or indirect) is not limited to the control illustrated in FIG. 19.

In some embodiments, one or more features and/or functions of a device to be controlled may be implemented in accordance with one or more aspects of one or more embodiments of any of the following co-pending patent applications, each of which is hereby expressly incorporated by reference in its entirety as part of the present disclosure: U.S. patent application Ser. No. 14,823,732, filed Aug. 11, 2015, entitled “Multifunction Pass-Through Wall Power Plug with Communication Relay and Related Method,” published as U.S. Patent Application Publication No. 2016/0044447 A1 on Feb. 11, 2016, which claims priority to U.S. Provisional Application No. 61/999,914, filed Aug. 11, 2014; and U.S. patent application Ser. No. 14/988,590, filed Jan. 5, 2016, entitled “IOT Communication Bridging Power Switch,” published as U.S. Patent Application Publication No. 2016/0209899 A1 on Jul. 21, 2016, which claims priority to U.S. Provisional Application No. 62/100,000, filed Jan. 5, 2015.

In some embodiments, one or more features and/or functions of a computing device for controlling a device may be implemented in accordance with one or more aspects of one or more embodiments of any of the above-cited co-pending patent applications.

Thus, for example, in some embodiments, the power switching device 1910, the corded device 1979 and/or the connected computing device 1980 may be the same as and/or similar to the power switching device 10, the power corded device 79 and/or the computing device 80, respectively, disclosed in U.S. patent application Ser. No. 14/988,590, filed Jan. 5, 2016, entitled “IOT Communication Bridging Power Switch,” published as U.S. Patent Application Publication No. 2016/0209899 A1 on Jul. 21, 2016, which claims priority to U.S. Provisional Application No. 62/100,000, filed Jan. 5, 2015, each of which is hereby expressly incorporated by reference in its entirety as part of the present disclosure.

In some embodiments, one or more of the devices disclosed herein may comprise a device produced by iDevices™ of Avon, Conn.

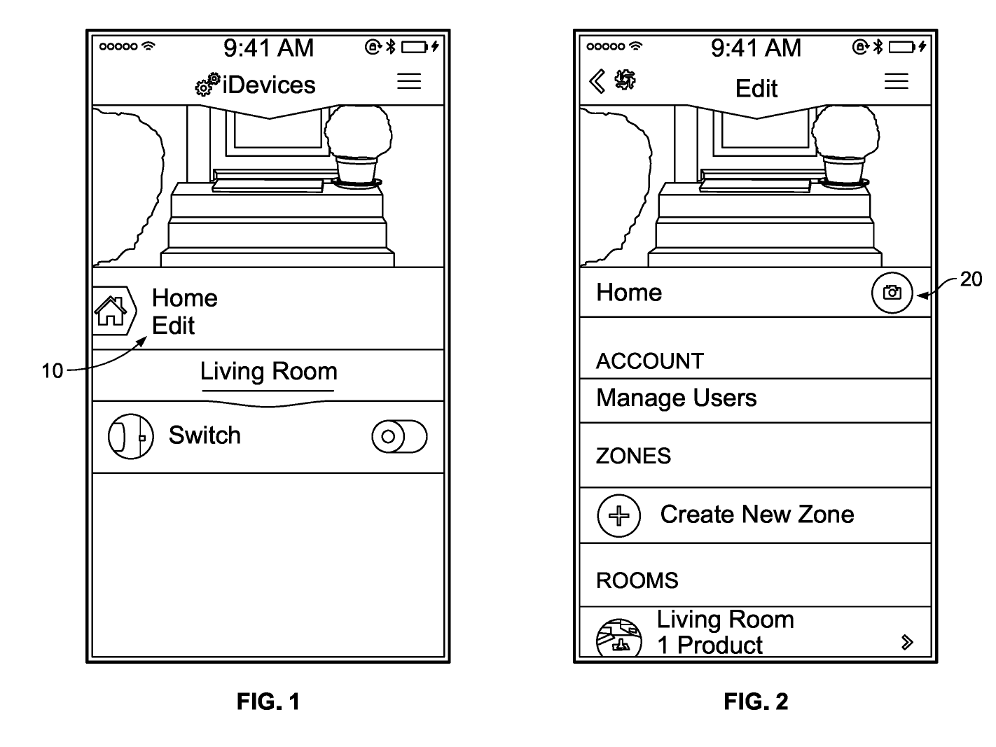

An embodiment of a computerized application and its use and operation will now described with reference to FIGS. 1-17.

FIG. 1 shows a view provided by a user interface of such application. In this embodiment, the user interface is implemented on a touch-enabled view screen, as should be understood by those of ordinary skill in the art, which visually displays information to a user and also allows a user to make inputs into the user interface by touching the screen at a location thereon. In this embodiment, the touchscreen is a capacitive touchscreen as is known. However, in other embodiments, the touchscreen, and the user interface, may be any suitable user interface, whether currently known or later becomes known. The interface screen includes buttons, icons and images that provide information to the user and also permits the user to input information and/or commands into the interface using the touchscreen capabilities.

In the illustrated embodiment, the application is adapted to control, via the user interface, one or more devices from a location that is remote from the one or more devices. The term “remote” as used herein refers to that the user is not directly interfacing with the device that is being controlled, but rather is controlling the device through a computerized device, e.g., a mobile or smart phone, that is in communication with, or placeable into communication with, directly or indirectly, with the device to be controlled. The communication between the application/program, the computerized device and the remotely-located device can be accomplished by any means or mechanism that is currently known or later becomes known. Such communication can be wired or wireless, or any suitable combinations thereof. Such communication may utilize any suitable communication protocol or protocols. In some embodiments, the communication may be secure or encrypted, or partially secure or encrypted, in order to help prevent unauthorized access to or control of the device or devices that the application controls or monitors.

In some embodiments, the computerized device may be the same as and/or similar to one or more the computing device(s) discussed above, e.g., computing devices 1818₁-1818ₚ.

As seen in FIG. 1, the screen contains several items of information. Among other information, the screen shows information regarding a location or building at which a device controlled or monitored by the application is located, a room or area in which such device is located, and the device itself. In the illustrated embodiment, the application comes pre-loaded with standard or pre-selected images to represent the location or building, the area or room, and one or more devices. In the illustrated embodiment, in FIG. 1, standard images and icons represent the user's location/building, in this embodiment a home, an area or room within the user's home, in this embodiment a Living Room, and a device, in this case a switch.

The application is configured and adapted to permit a user to customize one or more images and icons to represent these locations, areas and devices. In this exemplary embodiment, the application is adapted to permit a user to take a photo or image of the location, area and devices by utilizing a camera or imager of the computerized device. If the application is installed onto a smart phone having a camera, for example, the application allows a user to customize the icons and images by taking a photo with the camera of the phone. However, in other embodiments, the user may, alternatively or in addition, upload or input a custom image or icon from another source, such as memory of the computerized device (e.g., photos previously-taken with the smart phone) or another source, e.g., an image or icon located in memory of a separate electronic device, such as another computerized device, memory storage device, the Cloud, etc.

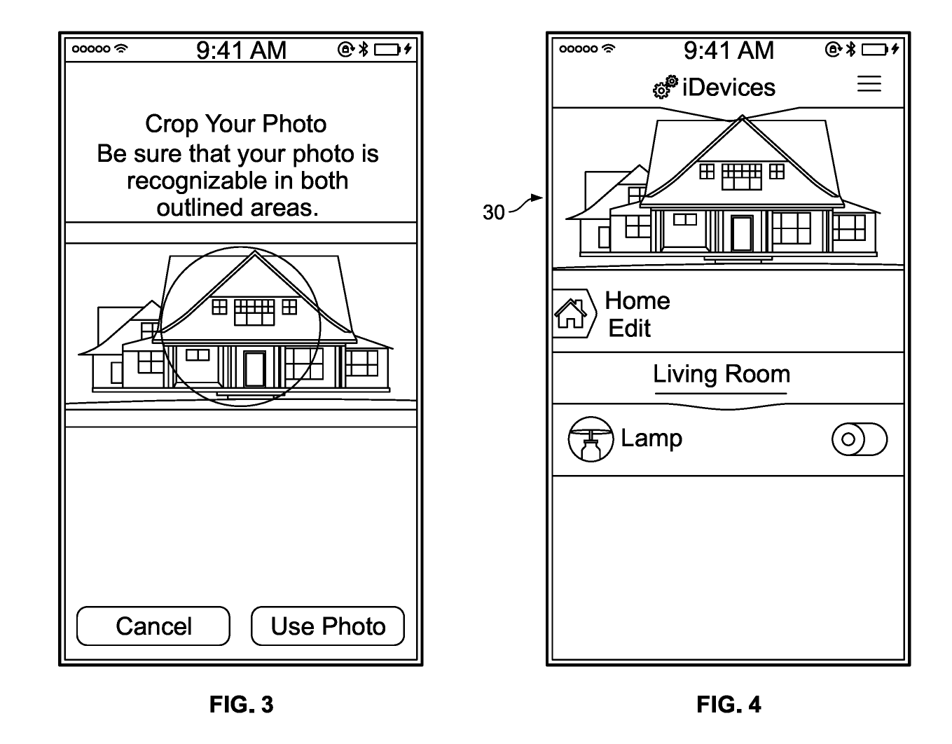

A procedure for customizing the icon or image of the location where the device is located, in this case the user's home, is described with reference to FIGS. 1-4. The screen shown in FIG. 1 contains an Edit Button 10 adjacent the “Home” icon and associated text. To customize the “Home” icon, a user touches or taps the Edit Button 10. When the Edit Button 10 is pressed, the screen shown in FIG. 2 is presented to the user. The user may then press the Camera Icon 20, in response to which application launches or activates the camera function of the computerized device. Once the user takes a picture of the home, which is visible in the screen shown in FIG. 3, the user can align and crop the picture within the guidelines as desired. Then, by touching the “Use Photo” button, the screen shown in FIG. 4 is displayed to the user. As seen in FIG. 4, the user's photo 30 has replaced the standard image seen in FIG. 1.

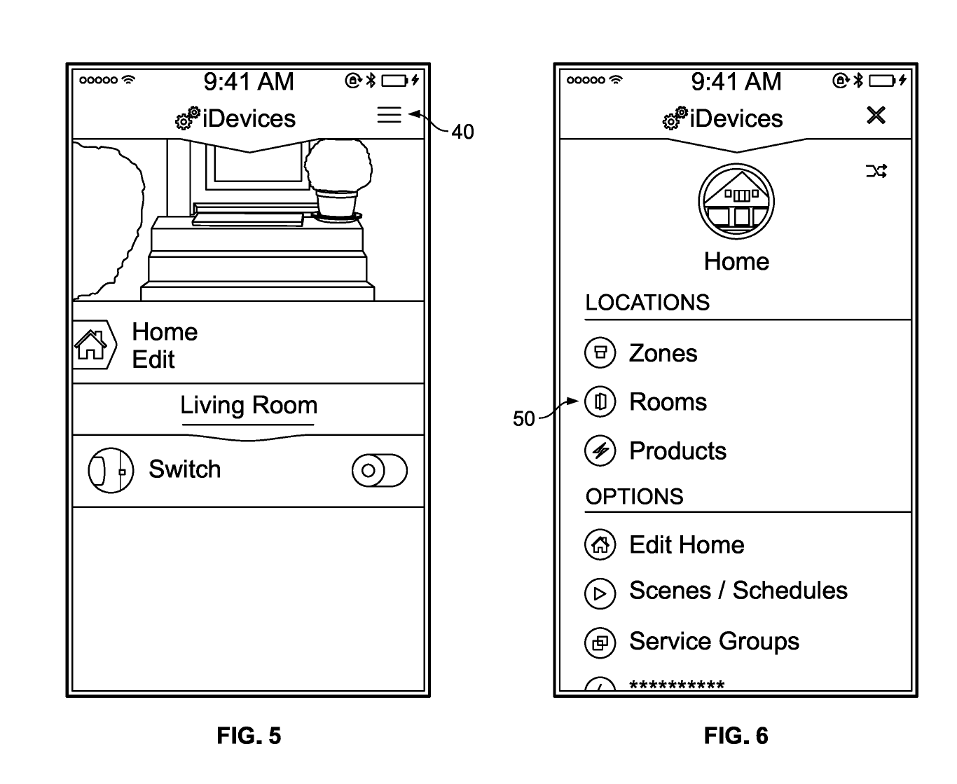

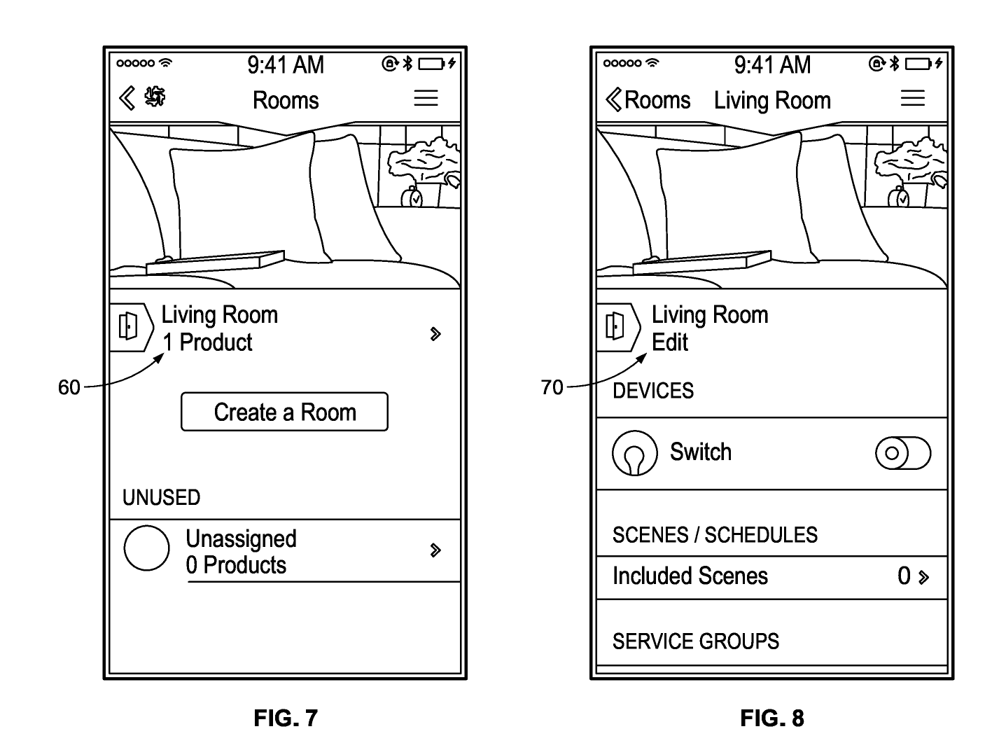

Referring now to FIGS. 5-11, the user may also, if desired, customize the image/icon of an area within the user's home, in this example the user's Living Room. To do so, the user taps the Menu Icon 40 on the touchscreen. In response to this action, the application displays the screen shown in FIG. 6. To customize a room the user touches the Rooms Button 50. In response to this action, the application displays the rooms screen shown in FIG. 7. On this screen, the application displays the room or areas that have been created or entered into the application. As seen in the example shown in FIG. 7, the application contains only one room, the Living Room. However, as seen in FIG. 7, the screen also contains a “Create a Room” but that permits a user to create additional room.

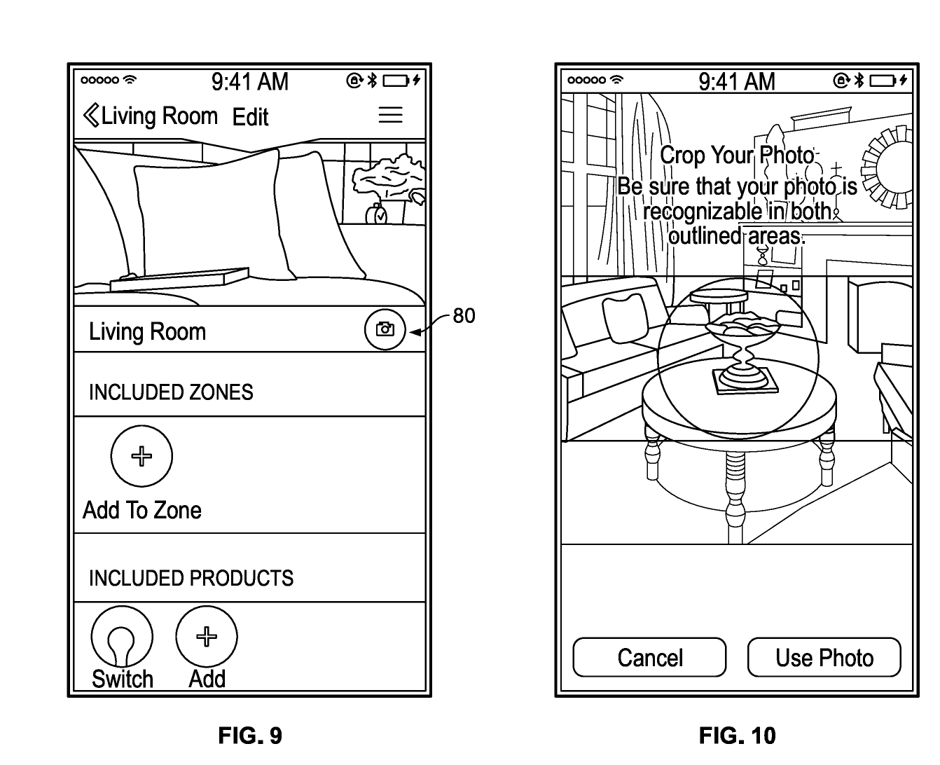

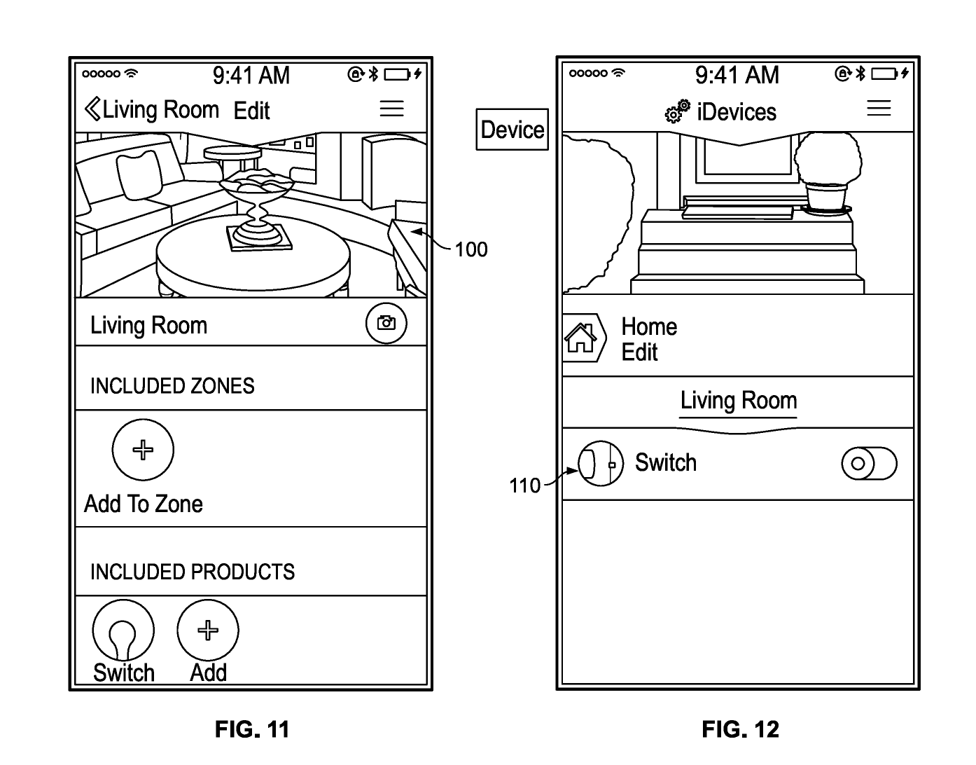

As seen in FIG. 7, the Living Room image is a stock or standard image in the application. To customize the icon, the user taps the Room Button 60 (which, in the illustrated example, is the Living Room), in response to which the application displays the screen shown in FIG. 8. The user then touches the Edit Button 70, and the application displays the screen shown in FIG. 9. The user then taps the Camera Button 80 to take a picture of the user's room or area (the Living Room in the illustrated embodiment), similar to as described above with respect to the user's house and depicted in FIG. 10. Upon touching the “Use Photo” button seen in FIG. 10, the application returns to and displays the screen depicted in FIG. 9, but now modified to include the user's photo 100 as seen in FIG. 11.

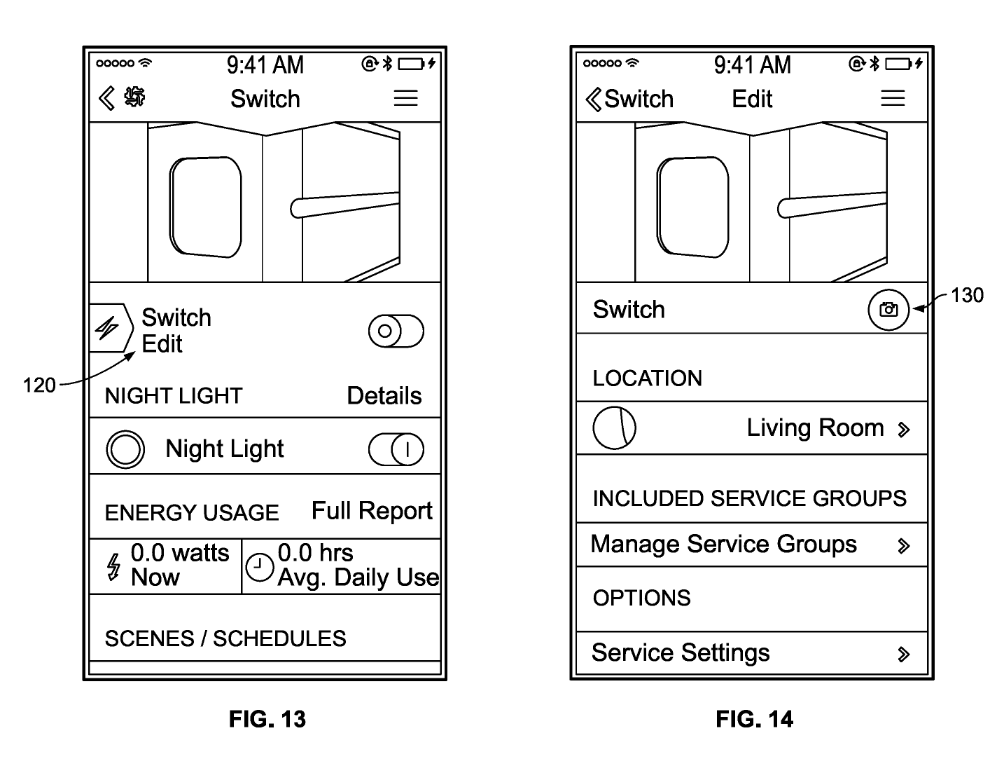

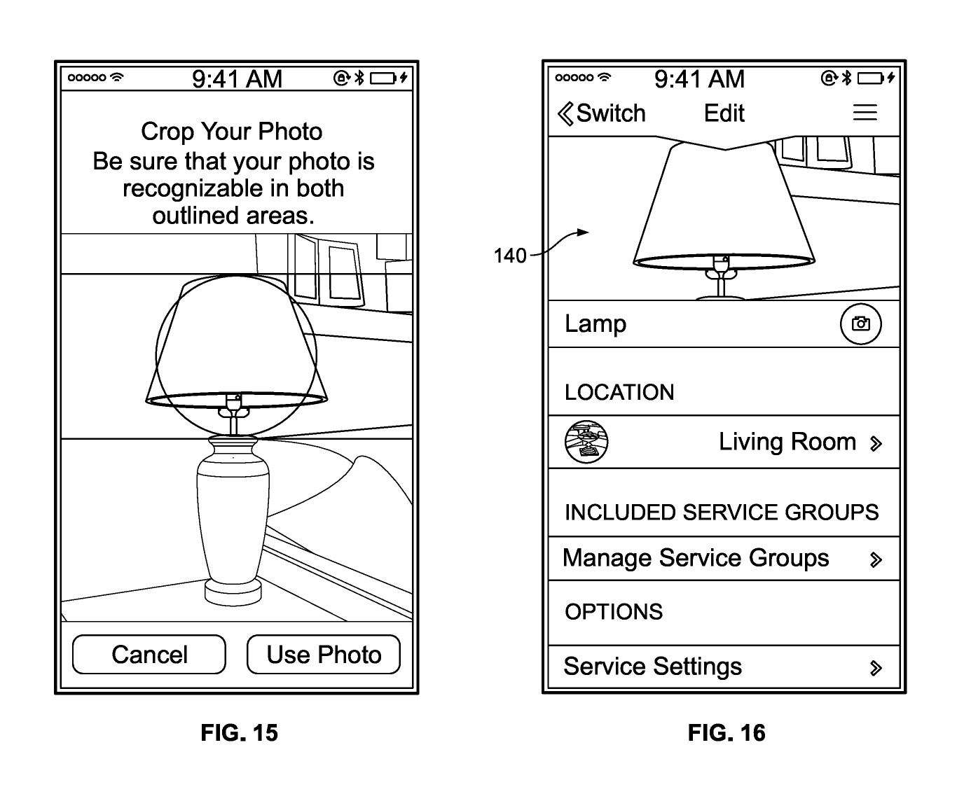

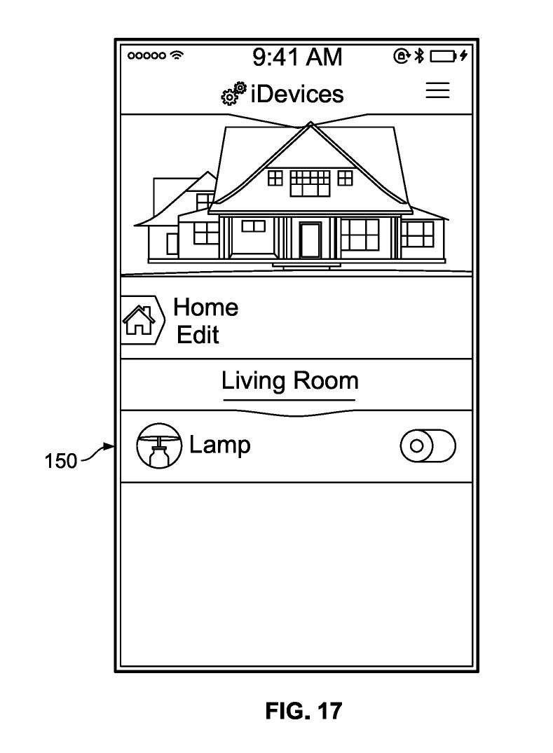

Referring now to FIGS. 12-17, the user may also, if desired, customize the image/icon for a particular device within the application. As illustrated, a user touches the Device Button 110, in response to which the application displays the screen shown in FIG. 13. As seen in FIG. 13, the application displays a standard icon for the selected device (here a Switch). To customize the icon, the user taps the Edit Button 120, and the application displays the screen shown in FIG. 14. The user then taps the Camera Button 130 to take a picture of the device (a lamp in the illustrated embodiment), similar to as described above with respect to the user's house and room and depicted in FIG. 14. Upon touching the “Use Photo” button seen in FIG. 15, the application displays the screen shown in FIG. 16, but now modified to include the user's photo 140 of the lamp as seen in FIG. 16. The new Lamp Icon 150 is also displayed in the home screen as seen in FIG. 17.

It should be understood that while the above embodiment is described with respect to showing the modification of images and icons for certain locations, rooms and devices, the invention may be utilized to customize icons and images for any locations, buildings, areas, rooms and devices as desired by a user. Further, the illustrated screens, displays, icons, buttons and designs thereof are merely exemplary, and the invention contemplates the use of other screens, displays, icons, buttons and designs.

It should also be understood that while the above embodiment is described with respect to modification of images and icons for locations, buildings, areas, rooms and/or devices, the present disclosure is not limited to embodiments that involve modifications.

In that regard, in at least some embodiments, a user may be provided with a capability to provide, if desired, images and icons for locations, buildings, areas, rooms and/or devices that do not already have images or icons associated therewith.

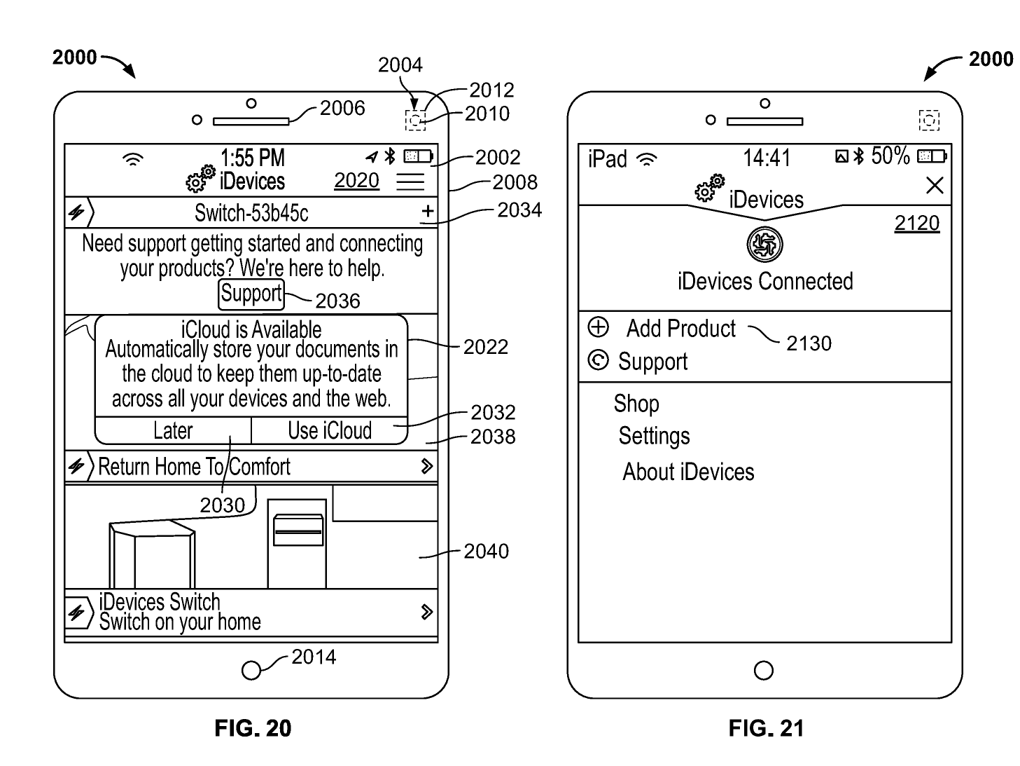

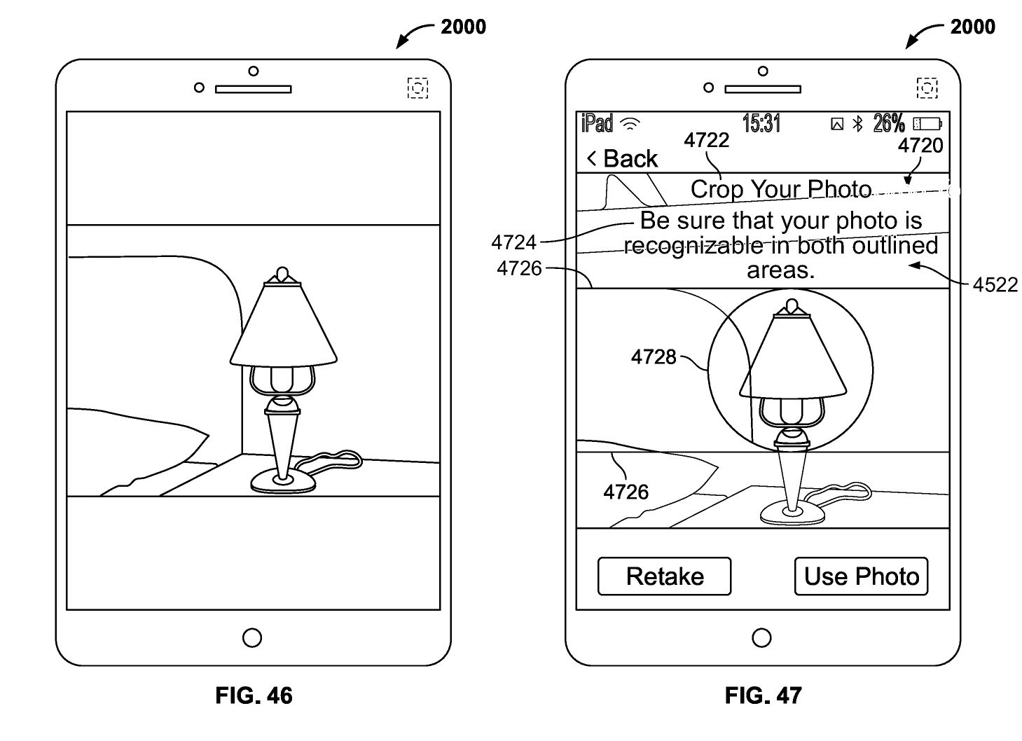

FIGS. 20-52 are schematic representations of a mobile computing device 2000 that may display a sequence of views in a graphical user interface, in accordance with some embodiments.

The views in the schematic representations are modified versions of embodiments of views that are used in some embodiments in order to facilitate labeling and pointing to features in the representations. Specifically, the views that are used in some embodiments have a background (and color images and icons). To create the schematic representations, the pixel values of such views were inverted (and converted to gray scale), to as stated above, facilitate labeling and pointing to features in the representations. Gray scale versions of such views (which can be generated by inverting the pixel values in the schematic representations) and color versions of the views (which can be generated by converting the gray scale values back to color values) are also part of this disclosure. Other representations of any of the above representations or actual views are also part of the present disclosure. For example, line drawing versions that do not include “fill” areas, to further facilitate labeling, pointing to features and/or reproduction of the drawings, are also part of the present disclosure.

In accordance with some embodiments, the sequence of views may provide a user with the capability to provide, if desired, images and icons for locations, buildings, areas, rooms and/or devices that do not already have images or icons associated therewith.

In some embodiments, the sequence may be provided upon initial execution of a program or application for use in controlling one or more devices in one or more locations, in accordance with some embodiments.

The invention is not limited to the sequence(s) shown. Rather, in various embodiments, the disclosed processes and steps may be performed in any order that is practicable and/or desirable. Nor are the illustrated views limited to use in an initial execution of a program or application for use in controlling one or more devices in one or more locations.

In some embodiments, one or more of the views, or features or other portions thereof, may be used without one or more other ones of the views, or features or portions thereof.

In some embodiments, one or more of the views, or portions thereof, (and/or any other views disclosed herein) may be used in combination with one or more other views, or portions thereof.

In some embodiments, the computing device 2000 may be the same as and/or similar to one or more of the one or more computing devices, e.g., computing devices 1818₁-1818ₚ. The computing device 2000 may be any suitable computing device.

Referring to FIG. 20, in accordance with some embodiments, the mobile computing device 2000 may include a display 2002, a camera 2004, a speaker 2006 and a case 2008 that supports (directly and/or indirectly) the display 2002, the camera 2004 and/or the speaker 2006. The camera 2004 may include an aperture 2010 and an image sensor 2012.

The user device 2000 may further include a microphone (not shown) and an on/off button 2014 and/or other type of control that can be activated and/or otherwise used by a user to turn the computing device 2000 on and/or off.

The display 2002 is shown displaying a view 2020 in a graphical user interface provided by the computing device 2000, in accordance with some embodiments. The view 2020 includes a prompt 2022 to prompt the user to choose a location in which to store documents. The view 2020 further includes a plurality of graphical tools, e.g., graphical tools 2030-2032, which may be selected or otherwise activated (e.g., by a tap) by a user to allow the user to indicate the choice. For example, the graphical tool 2032 may be activated by the user to choose to have documents stored in iCloud® or other online service connected to the Internet. The graphical tool 2030 may be activated by the user to choose to have documents stored locally in the computing device.

In some embodiments, after the user chooses a location in which to store documents, the user may be prompted to choose from one or more available functions. A plurality of graphical tools, e.g., graphical tools 2034-2040, may be provided to allow the user to indicate the choice. One of the graphical tools, e.g., graphical tool 2036, may be activated by a user to choose to get support getting started and connecting products.

FIG. 21 shows the mobile computing device 2000 displaying a view 2120 that may be displayed if the user chooses to get support getting started and connecting products. The view 2120 may include a graphical tool, e.g., graphical tool 2130 that may be activated by a user to choose to add a product. If the user chooses to add a product, the computing device 2000 may determine whether there are any products that are in the user's ecosystem and not already setup. In some embodiments, products in the user's ecosystem may include all products that are communicatively coupled to the computing device 2000.

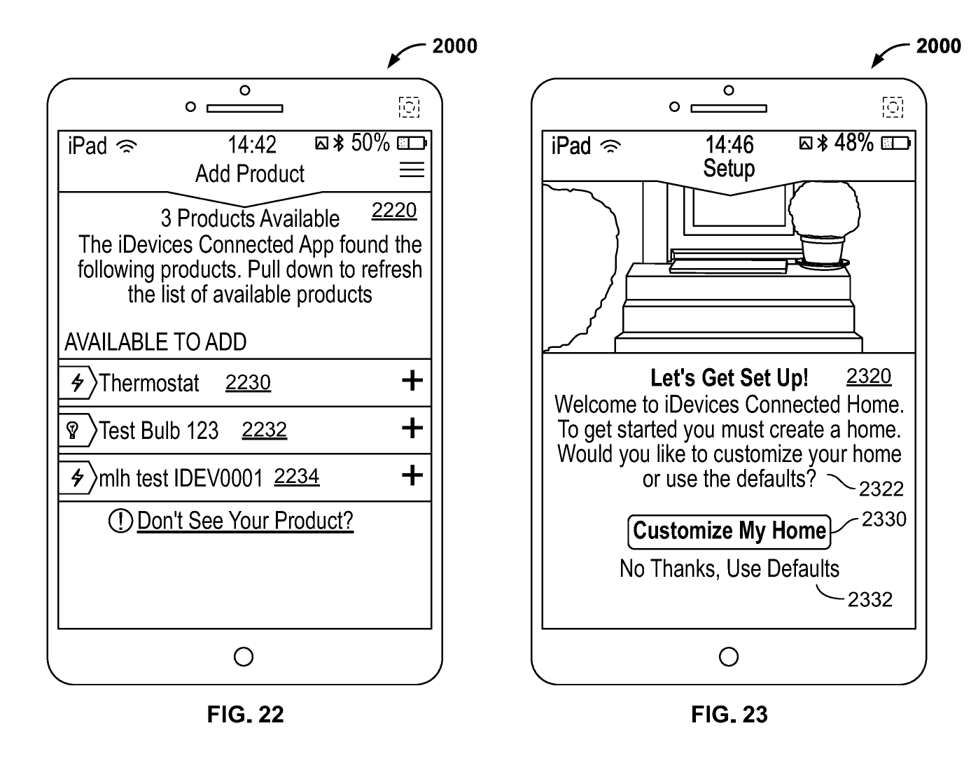

FIG. 22 shows the mobile computing device 2000 displaying a view 2220 that may be displayed if the user chooses to add a product. The view may include information, e.g., “Thermostat,” “Test Bulb 123” and “mlh test IDEV0001,” that indicates that one or more products in the user's ecosystem have not already been setup. The view may further include one or more graphical tools, e.g., graphical tools 2230-2234, which may be activated by a user to choose to add one of the products. Some embodiments may include a view (not shown) that prompts the user to confirm the choice.

FIG. 23 shows the mobile computing device 2000 displaying a view 2320 that may be displayed after the user confirms the choice. The view 2320 may include a prompt 2322 to prompt the user to choose whether to customize a name and/or icon associated with a user's home (or other location at which one or more device to be controlled is located) or use defaults. The view 2320 may further include a plurality of graphical tools, e.g., graphical tools 2330-2332, which may be activated by a user to allow the user to indicate the choice. For example, the graphical tool 2330 may be activated by the user to choose to customize the name and/or icon associated with the user's home (or other location at which one or more device to be controlled is located). The graphical tool 2332 may be activated by the user to choose to use defaults.

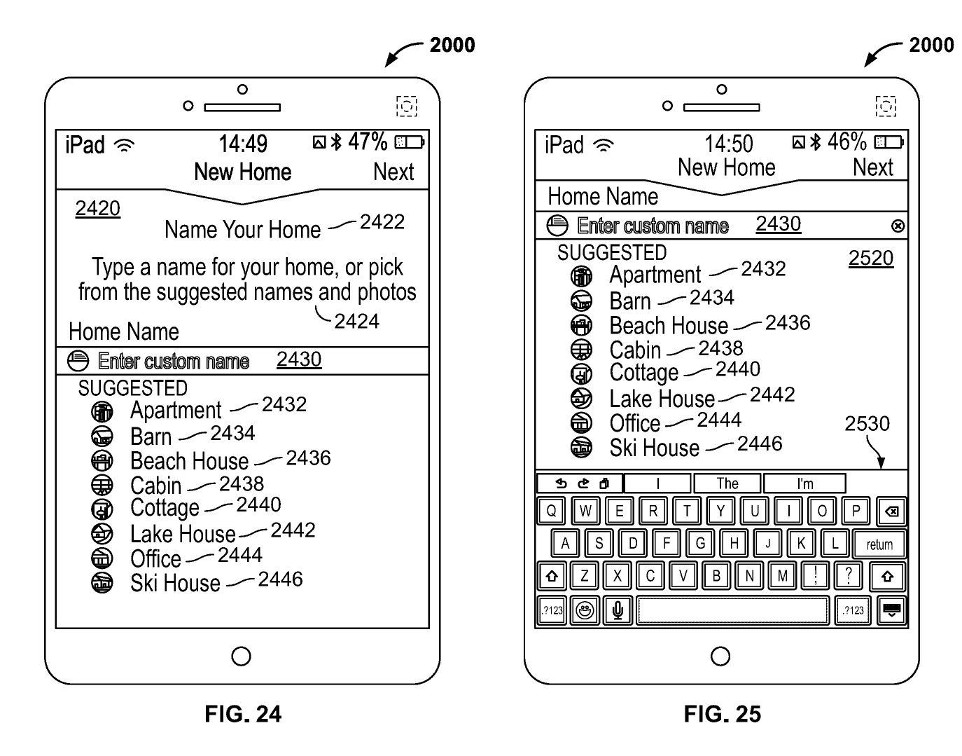

FIG. 24 shows the mobile computing device 2000 displaying a view 2420 that may be displayed if the user chooses to customize. The view 2420 may include one or more prompts, e.g., prompts 2422-2424, which may prompt the user to choose between entering a custom name and picking a name (and a respective photo (or other type of icon) associated therewith) from a plurality of suggestions provided by the computing device 2000, e.g., “Apartment,” “Barn,” “Beach House,” “Cabin,” “Cottage,” “Lake House,” “Office” and “Ski House.”

In some embodiments, at least some of the plurality of suggestions (and at least some of the photos (or other type of icon) associated therewith) provided by the computing device 2000, are included in or otherwise part of a program or application being executed by the computing device 2000.

The view 2420 may further include a plurality of graphical tools, e.g., graphical tools 2430-2446, which may be activated by a user to indicate the user's choice. For example, the graphical tool 2430 may be activated by the user to choose to enter a name. Alternatively, one of graphical tools 2432-2446 may be activated by the user to pick an associated one of the names suggested by the computing device 2000, e.g., “Apartment,” “Barn,” “Beach House,” “Cabin,” “Cottage,” “Lake House,” “Office” or “Ski House.” respectively (and the respective photo (or other type of icon) associated therewith).

In some embodiments, the number of suggestions in the plurality of suggestions may be too large to display all at one time. In some embodiments, the view 2420 may include one or more graphical tools that may be activated by a user (e.g., using a finger swipe) to allow the user to effectively scroll through the plurality of suggestions (or portion(s) thereof).

FIG. 25 shows the mobile computing device 2000 displaying a view 2520 that may be displayed if the user chooses (e.g., by a finger tap on graphical tool 2430) to enter a name (e.g., as opposed to picking a name and associated photo from the suggestions by the computing device 2000). The view 2520 may include one or more graphical tools, e.g., a graphical keyboard 2530, which allow(s) the user to enter a name (e.g., letter by letter). In some embodiments, the user may be given the option of choosing to enter a name without interaction with the graphical user interface, e.g., via a keyboard that is not in the view 2520 and/or via voice (e.g., by using the microphone) or other audio or other input device(s). (For that matter, in some embodiments, any choice, request, or other type of indication may be performed by the user, and/or any information may be input by the user, without interaction with the graphical user interface, e.g., via a keyboard that is not in the view 2520 and/or via voice (e.g., by using the microphone) or other audio or other input device(s).) The view 2520 may further include one or more other graphical tools, e.g., graphical tools 2432-2446, which may still be activated by the user to pick one of the names (and the respective photo (or other type of icon) associated therewith) from the plurality of suggestions.

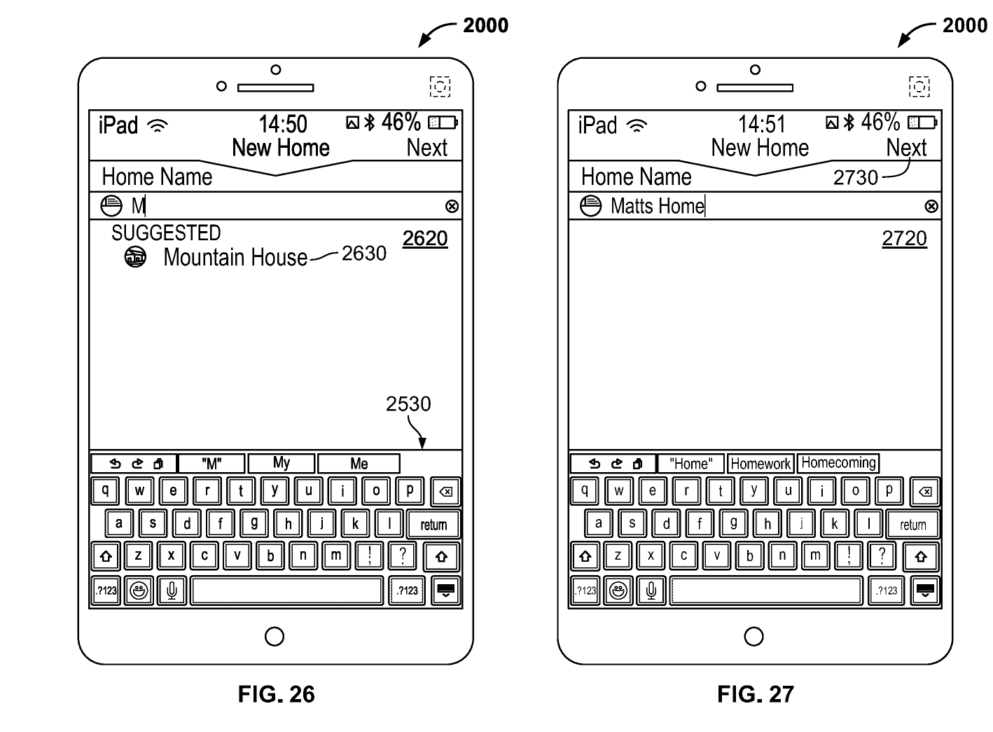

FIG. 26 shows the mobile computing device 2000 displaying a view 2620 that may be displayed after the user enters a letter (e.g., “M”). In some embodiments, the letter may be entered by tapping or touching on the corresponding letter on the graphical keyboard 2530. The view 2620 may include the letter entered by the user and the computing device 2000 may filter the plurality of suggestions based on such letter to identify a subset of the plurality of suggestions, e.g., “Mountain House” that begin with the letter entered by the user. If the subset is not empty, the view 2620 may further include one or more graphic tools, e.g., graphical tool 2630, which the user may activate to pick one of the suggestions in the subset (and the respective photo (or other type of icon) associated therewith).

FIG. 27 shows the mobile computing device 2000 displaying a view 2720 that may be displayed after the user enters additional letters. The view 2720 may include the additional letters entered by the user, and the computing device 2000 may further filter the plurality of suggestions based on such additional letters to identify a subset of the plurality of suggestions that begin with the letter sequence entered by the user. If the subset is not empty, the view 2720 may further include one or more graphic tools, which the user may activate to pick one of the suggestions in the subset (and the respective photo (or other type of icon) associated therewith). The view 2720 may further include one or more graphical tools, e.g., a graphical tool 2730, which may be activated by a user to indicate that the user has completed entry of the custom name.

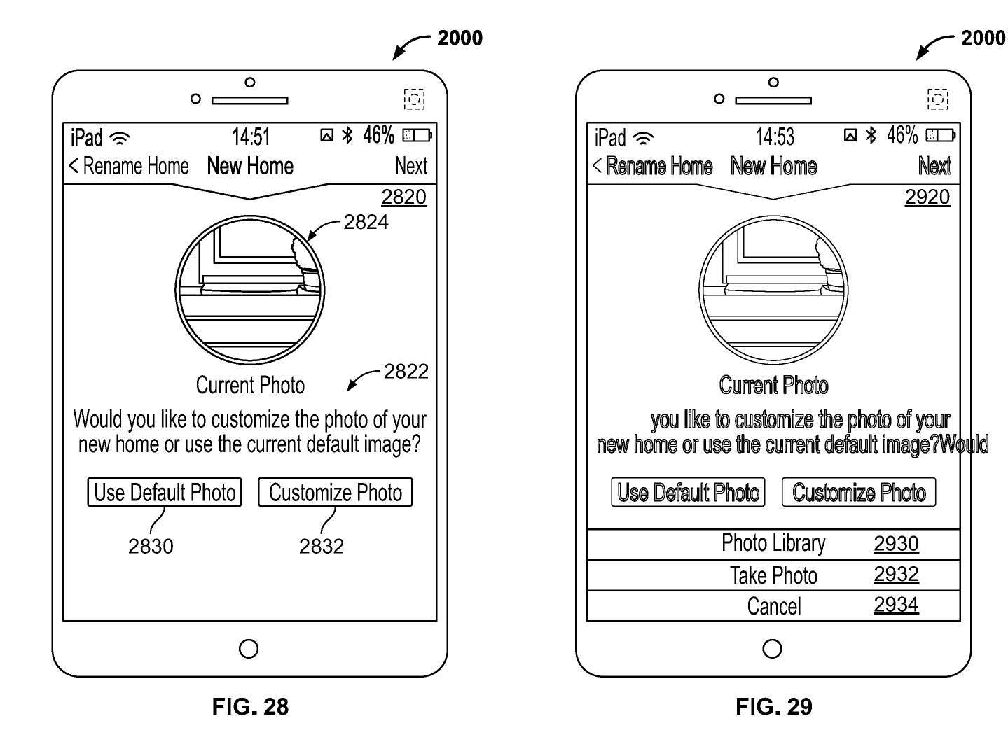

FIG. 28 shows the mobile computing device 2000 displaying a view 2820 that may be displayed after the user activates the graphical tool 2730 to indicate that entry of the custom name is completed. The view 2820 may include a prompt 2822 to prompt the user to choose whether to customize an icon associated with the user's home (or other location at which one or more device to be controlled is located) or use a default. The view 2820 may further include the default image 2824 and a plurality of graphical tools, e.g., graphical tools 2830-2832, which may be activated by the user to allow the user to indicate the choice. For example, the graphical tool 2830 may be activated by the user to choose to use the default image. The graphical tool 2832 may be activated by the user to choose to customize.

FIG. 29 shows the mobile computing device 2000 displaying a view 2920 that may be displayed if the user chooses to customize an icon associated with the user's home (or other location at which one or more devices to be controlled is located). The view 2920 may include a plurality of graphical tools, e.g., graphical tools 2930-2934, which may be activated by a user to choose how to customize or to cancel the choice to customize. For example, the graphical tool 2930 may be activated by the user to choose to customize using a photo library or other type of library. The graphical tool 2932 may be activated by the user to choose to customize by taking a photo. The graphical tool 2934 may be activated by the user to cancel the choice to customize.

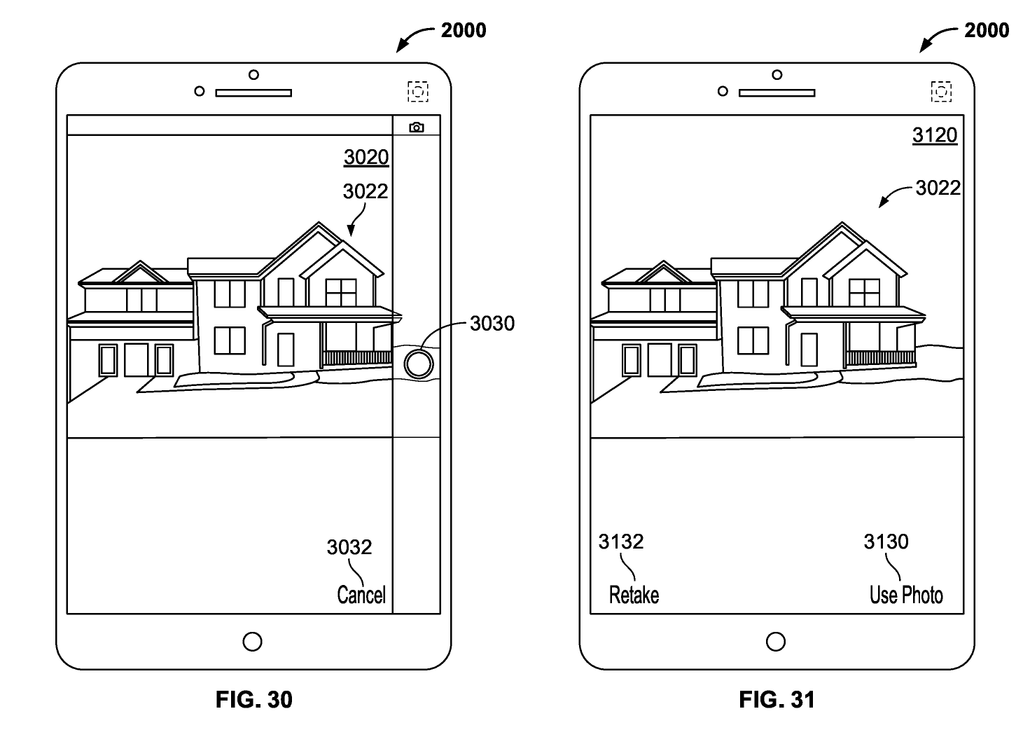

FIG. 30 shows the mobile computing device 2000 displaying a view 3020 that may be displayed if the user chooses to customize by taking a photo and then positions and/or otherwise orients the computing device 2000 such that the camera 2004 is directed toward the user's house (or other location at which one or more device to be controlled is located). The view 3020 may include an image 3022 of the house or other location at which the camera is directed, and may further include a plurality of graphical tools, e.g., graphical tools 3030-3032. The graphical tool 3030 may be activated by the user to capture the image 3022. The graphical tool 3032 may be activated by the user to cancel the choice to customize by taking a photo.

FIG. 31 shows the mobile computing device 2000 displaying a view 3120 that may be displayed if the user chooses to captures the image 3022. The view 3120 may include the captured image 3022 and may further include a plurality of graphical tools, e.g., graphical tools 3130-3132, which may be activated by the user to indicate whether to use the photo or retake the photo. For example, the graphical tool 3030 may be activated by the user to choose to use the image. The graphical tool 3032 may be activated by the user to choose to retake the photo.

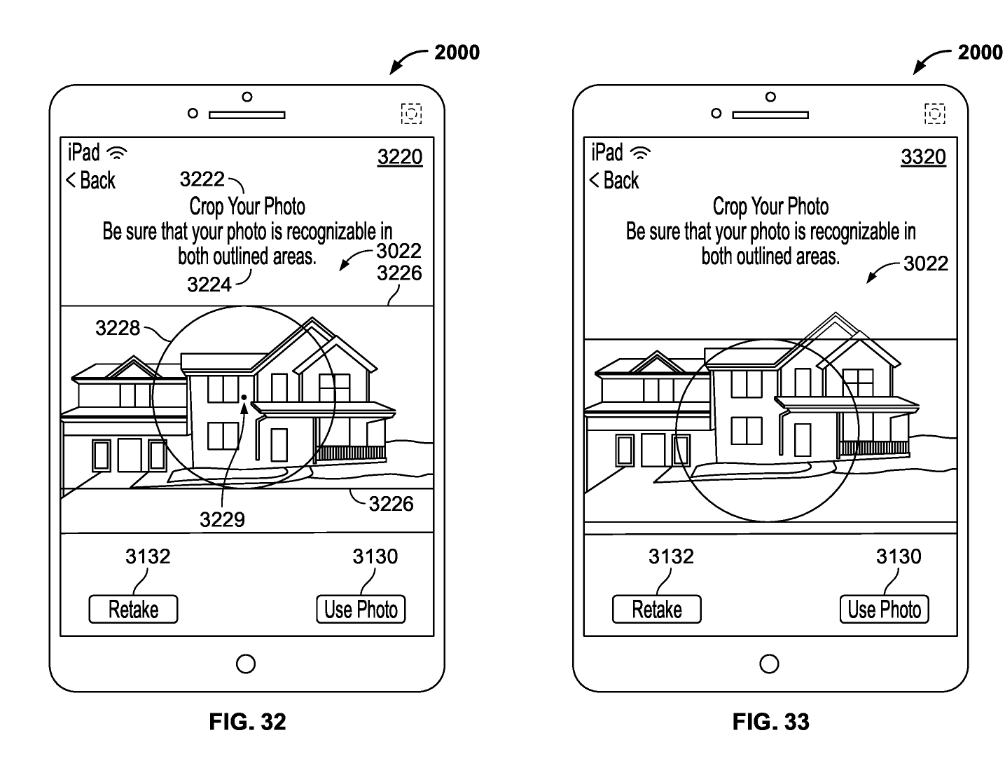

FIG. 32 shows the mobile computing device 2000 displaying a view 3220 that may be displayed if the user chooses to use the image 3022. The view 3220 may include one or more prompts, e.g., prompts 3222-3224, which may prompt the user to specify or otherwise define how the photograph should be cropped.

To assist the user, the view may include a first outline, e.g., outline 3226, that has a first size and/or shape and shows what portions of the photograph will be cropped from the photograph (and, conversely, what portions of the photograph will be retained) unless one or more adjustments are made. The user may make adjustments by moving the photograph within the view 3220 (sometimes referred to herein as panning) and/or by zooming in and/or out so as to position a desired portion of the photograph within the first outline 3226.

To assist the user in this regard, the view 3220 may include one or more graphical tools that may be activated by the user to allow the user to zoom in, zoom out, pan left, pan right, pan up and/or pan down. In some embodiments, one or more of the graphical tools may be activated by finger gestures. For example, a pinch gesture may represent a request to zoom out. A reverse pinch gesture may represent a request to zoom in. Finger swipes may represent requests to pan.

In some embodiments, it may be desirable to have one cropped version of the photograph that is cropped to the first size and/or shape (of the first outline 3226) for use in association with one or more views in the graphical user interface and to have a second cropped version of the photograph that is cropped to a second size and/or shape for use in association with one or more other views in the graphical user interface.

To that effect, in some embodiments, the view 3220 may further define a second outline, e.g., outline 3228, that has a second size and/or shape and shows what portions of the photograph will be cropped to create a second cropped version of the photograph unless one or more adjustments are made.

The user may make adjustments by moving the photograph within the view 3220 and/or by zooming in or out so as to position a portion of the photograph desired for the first cropped version within the first outline 3226 and so as to, at the same time, position a portion of the photograph desired for the second cropped version within the second outline 3228.

The prompt 3224 may prompt the user to be sure that the photograph is recognizable in both outlined areas 3226, 3228.

In some embodiments, the use of one view, e.g., view 3220, to define two cropped versions of the photograph may make it easier to capture certain features in both versions, and may thereby make it easier for a user to recognize that the first cropped version and the second cropped version are photographs of the same thing.

In some embodiments, the first outline 3226 defines an area having a center disposed at a point 3229 in the view 3220 and the second outline 3228 defines an areas having a center disposed at the same (or at least substantially the same) point 3229 in the view 3220. In some embodiments, this may make it easier to capture certain features in both cropped versions, and may thereby make it easier for a user to recognize that the first cropped version and the second cropped version are photographs of the same thing.

In some embodiments, the first outline 3226 is rectangular and/or at least substantially rectangular, and the second outline 3228 is circular and/or at least substantially circular. However, the outlines may be of any suitable or desired shape(s).

It should be understood however, that there is no absolute requirement to use one view to define two cropped versions of the photograph. It should also be understood that some embodiments may not define two cropped versions.

FIG. 33 shows the mobile computing device 2000 displaying a view 3320 that may be displayed after the user has positioned the photograph so as to define how the photograph should be cropped to create the first cropped version of the photograph and the how the photograph should be cropped to create the second cropped version of the photograph.

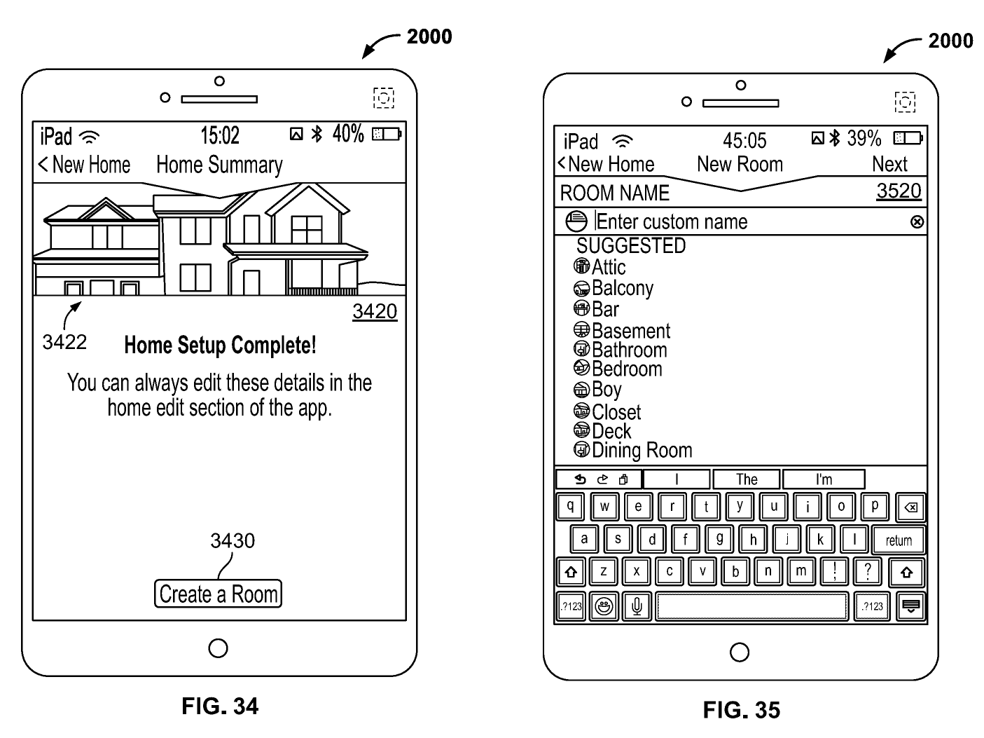

FIG. 34 shows the mobile computing device 2000 displaying a view 3420 that includes the first cropped version of the photograph 3422. The view 3420 may further include one or more graphical tools, e.g., graphical tool 3430, which may be activated by the user to allow the user to create a custom name and/or icon for a room in the user's home (and/or other location).

FIG. 35 shows the mobile computing device 2000 displaying a view 3520 that may be displayed if the user chooses to initiate a process to create a custom name and/or icon for a room in the user's home (and/or other location).

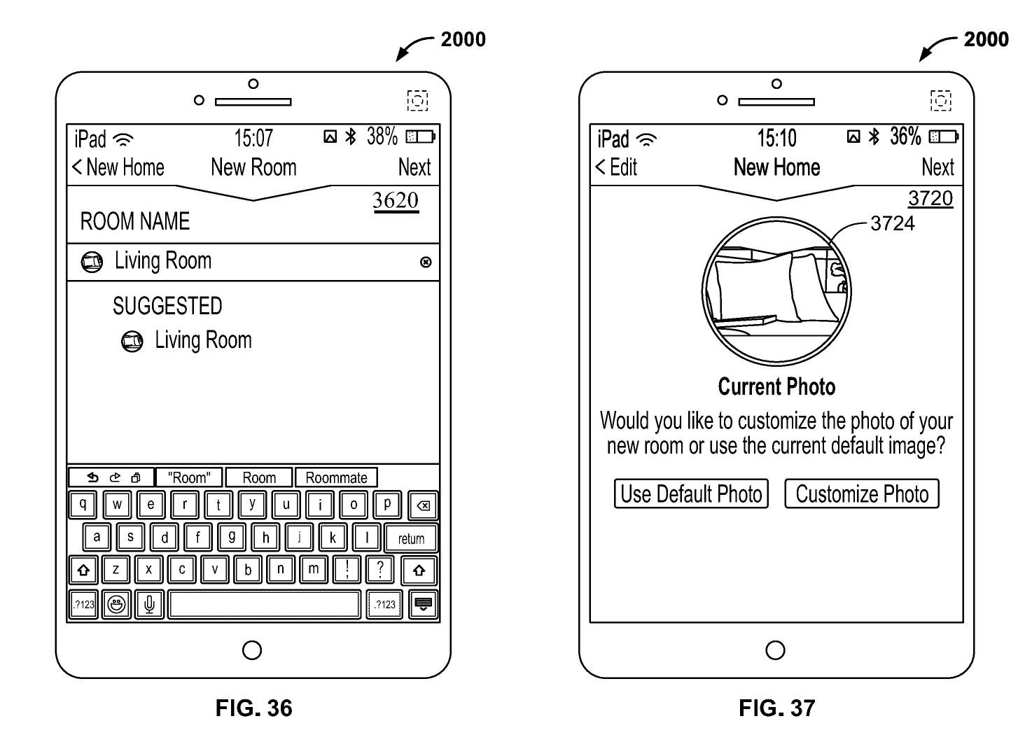

FIGS. 36-39 are schematic representations of a mobile computing device 2000 that displays a sequence of views associated with creating a custom name and icon for a room in the user's home (and/or other location).

The sequence of views displayed in FIGS. 36-39 and associated with creating a custom name and icon for a room in the user's home (and/or other location) are similar to the sequence of views displayed in FIGS. 25-34 and associated with creating the custom name and icon for the user's home (and/or other location) except that in the sequence of views displayed in FIGS. 36-39, the user chooses, for the custom name of the room, one of the names suggested by the computing device 2000.

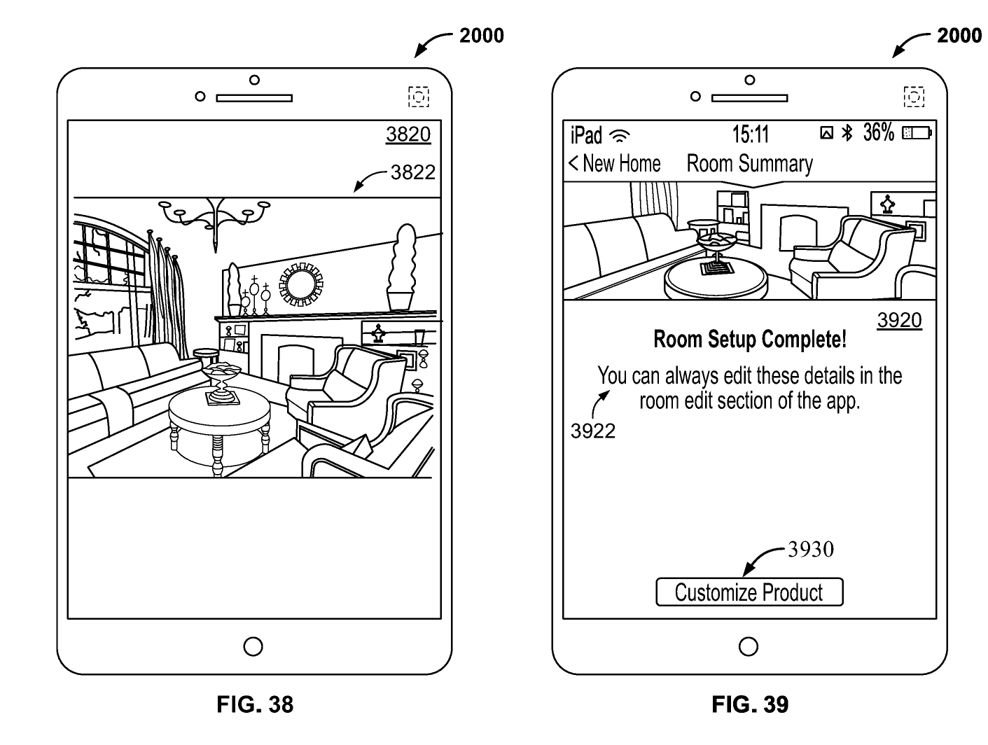

For example, FIG. 36 shows the mobile computing device 2000 displaying a view 3620 that includes the custom name chosen for the room, e.g., “Living Room.” FIG. 37 shows the mobile computing device 2000 displaying a view 3720 that includes a default photo 3724 associated with the room name “Living Room.” FIG. 38 shows the mobile computing device 2000 displaying a view 3820 that includes a custom photograph 3822 to be associated with the room name “Living Room.” FIG. 39 shows the mobile computing device 2000 displaying a view 3920 that includes a first cropped version of the photograph 3922. The view 3920 may further include one or more graphical tools, e.g., graphical tool 3930, which may be activated by the user to allow the user to create a custom name and/or icon for a product in the user's home (and/or other location).

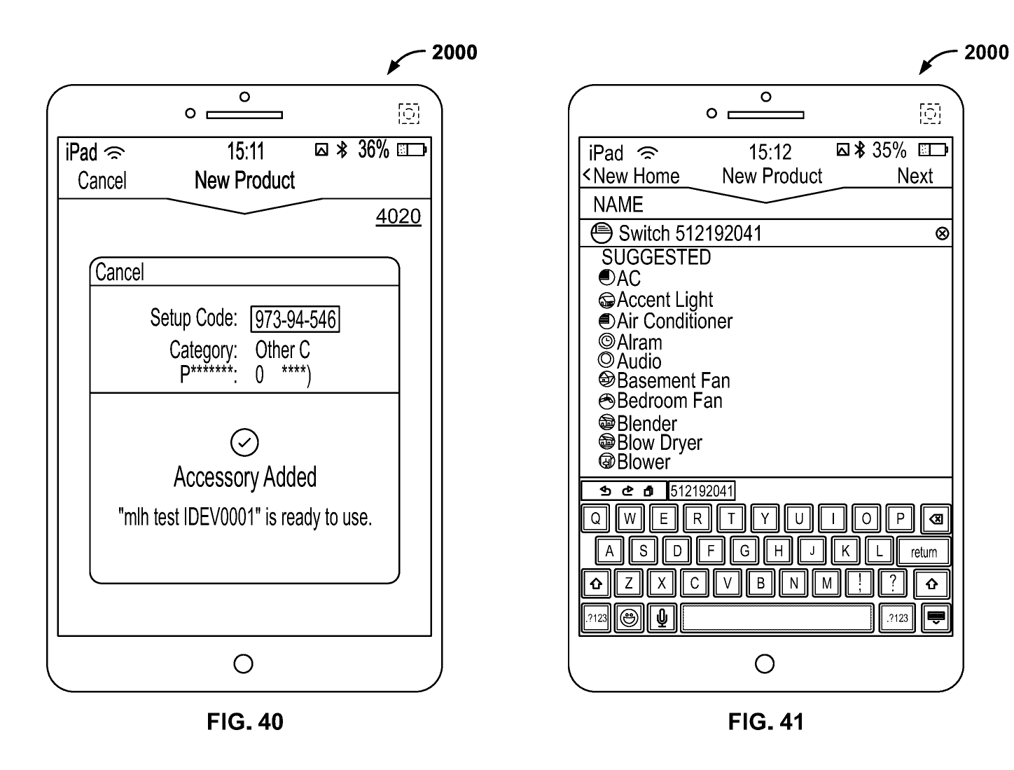

FIG. 40 shows the mobile computing device 2000 displaying a view 4020 that may be displayed if the user chooses to initiate a process to create a custom name and/or icon for a product, e.g., “mlh test IDEV0001,” in the user's home (and/or other location). The product e.g., “mlh test IDEV0001,” may be one of the products indicated in the view 2220 of FIG. 22.

Although it may not be immediately apparent from FIG. 40, the particular product referenced in FIG. 40 is a power-switching device. A perspective view representation of the power-switching device is shown in FIG. 43. In some embodiments, the power-switching device may be the same as and/or similar to one or more power switching devices in any of the above cited co-pending patent applications.

FIGS. 41-49 are schematic representations of a mobile computing device 2000 that displays a sequence of views associated with creating a custom name and icon for the product (in this embodiment, a power switching device). In some embodiments, a similar sequence of views may be used in association with creating a custom name and icon for other products in the user's home (and/or other location).

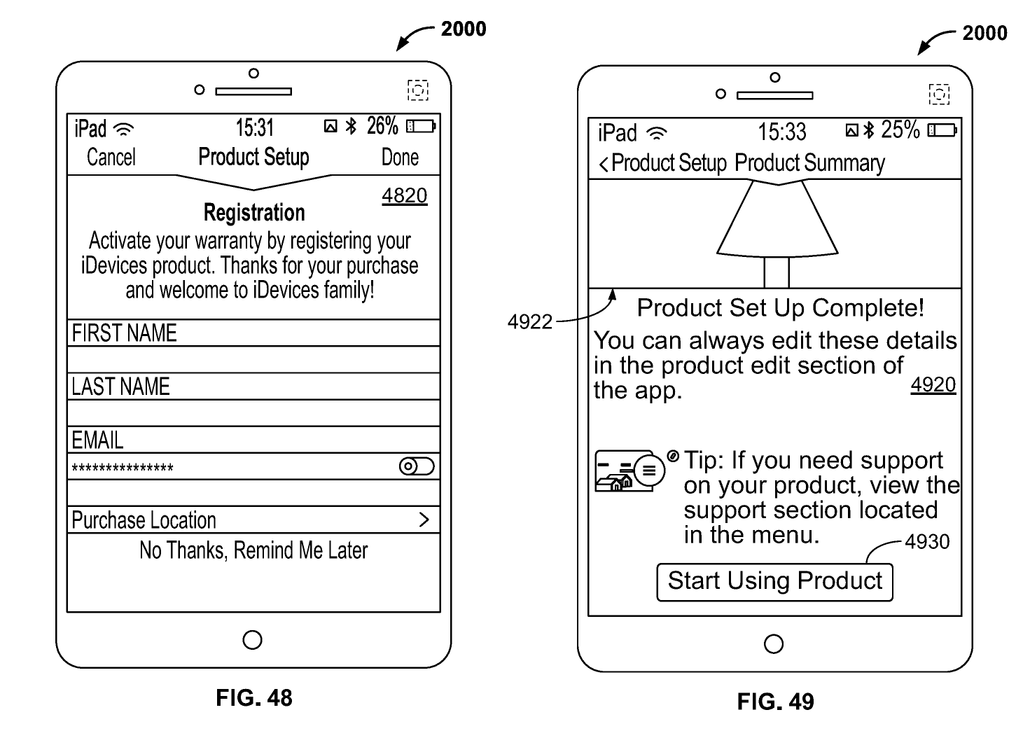

The sequence of views displayed in FIGS. 41-49 and associated with creating a custom name and icon for the product in the user's home (and/or other location) are similar to the sequence of views displayed in FIGS. 25-34 and associated with creating the custom name and icon for the user's home (and/or other location) except that the sequence of views displayed in FIGS. 41-49, includes a view 4320 (FIG. 43), which shows a perspective view representation of the product (in this embodiment, a power switching device) to be directly controlled and prompts the user to choose a manner in which to have Ski® recognize the custom name of the product (in this embodiment, the user has chosen “Lightbulb” in view of that the power switching device will be used to control a lamp), and further includes a view 4820 (FIG. 48) that prompts the user to choose whether to proceed to register the product with a manufacturer thereof.

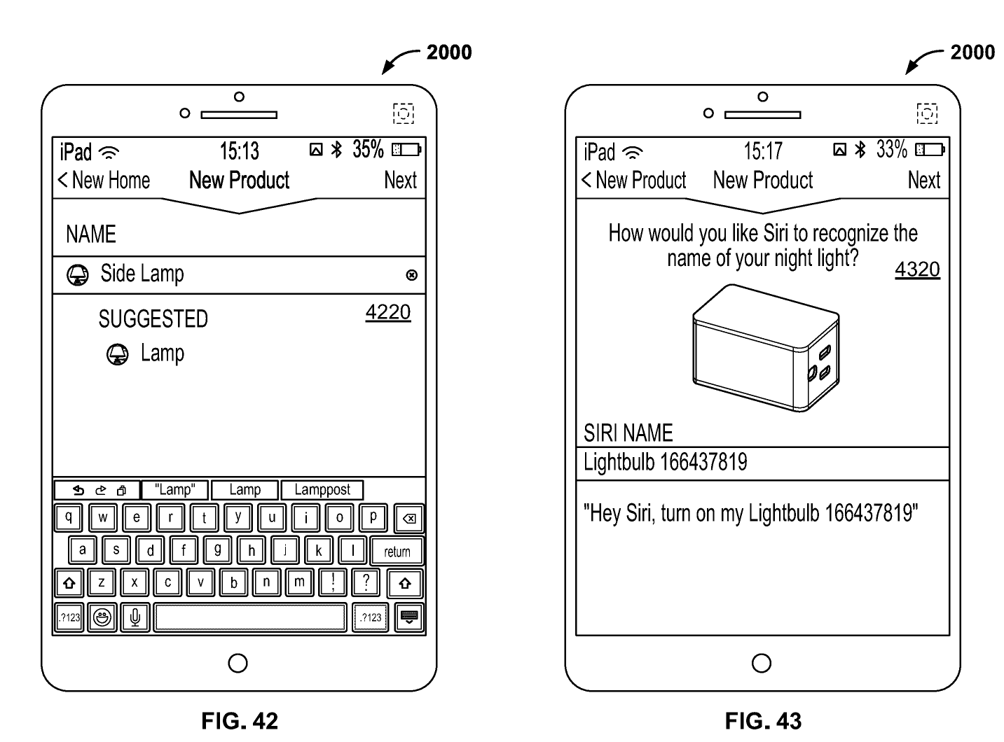

For example, FIG. 42 shows the mobile computing device 2000 displaying a view 4220 that includes a custom name, e.g., “Side Lamp,” which has been chosen by the user, and which in this embodiment, may describe or otherwise represent a device (e.g., a lamp that is plugged into or will be plugged into the power switching device) that the computing device 2000 (or some other computing device(s), e.g., computing devices 1818₁-1818ₚ) will use the power switching device to control.

Thus, in some embodiments, the custom name chosen for a product (to be controlled) may not describe the product but rather may represent the product in an indirect way. Thus, in some embodiments, the custom name may describe the device that will be indirectly controlled using the product. In some embodiments, the representation may be even more indirect, for example, the name (or other representation) of a person that gave the product (or the device that will be indirectly controlled using the product) to the user.

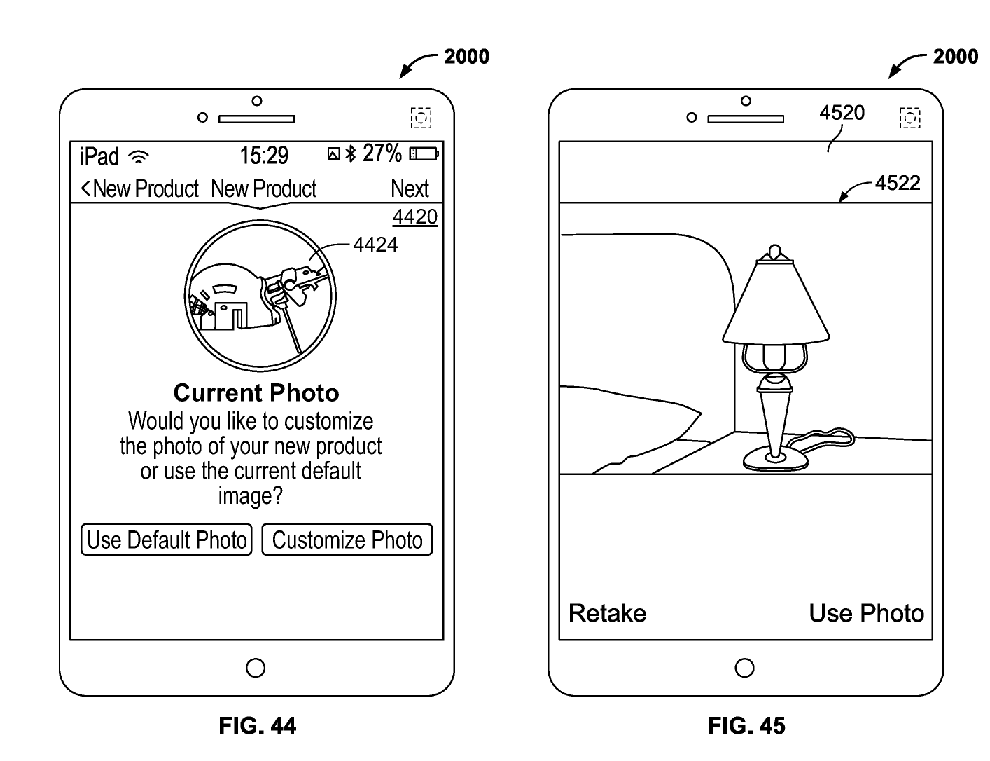

FIG. 43 shows the mobile computing device 2000 displaying a view 4320 that shows a perspective view representation of the product that will be directly controlled by the computing device 2000 (or other computing device(s), e.g., computing devices 1818₁-1818ₚ), in this embodiment, the power switching device. FIG. 44 shows the mobile computing device 2000 displaying a view 4420 that includes a default photo 4424 for the product. In this embodiment, the default photo is a default photo representing the product, in this embodiment, a switch. FIG. 45 shows the mobile computing device 2000 displaying a view 4520 that includes a custom photograph 4522 that may be associated with the product and/or with the custom name “Side Lamp.” Thus, in some embodiments, a custom photo or other icon chosen for a product may describe or otherwise represent a device that will be indirectly controlled using the product, and may not have any other relation to product.

Thus, in some embodiments, a custom photo or other icon chosen for a product may not be of the product but rather may represent the product in an indirect way. Thus, in some embodiments, the custom photo or other icon may be of the device that will be indirectly controlled using the product. In some embodiments, the representation may be even more indirect, for example, a photo or other representation of a person that gave the product (or the device that will be indirectly controlled using the product) to the user.

FIG. 47 shows the mobile computing device 2000 displaying a view 4720 that may be displayed if the user chooses to use a custom image 4522. The view 4720 may include one or more prompts, e.g., prompts 4722-4724, which may prompt the user to specify or otherwise define how the photograph should be cropped. The view 4720 may further include a first outline 4726 and a second outline 4728. FIG. 49 shows the mobile computing device 2000 displaying a view 4920 that includes a first cropped version of the photograph 4922. The view 4920 may further include one or more graphical tools, e.g., graphical tool 4930, which may be activated by the user to allow the user to start using the product.

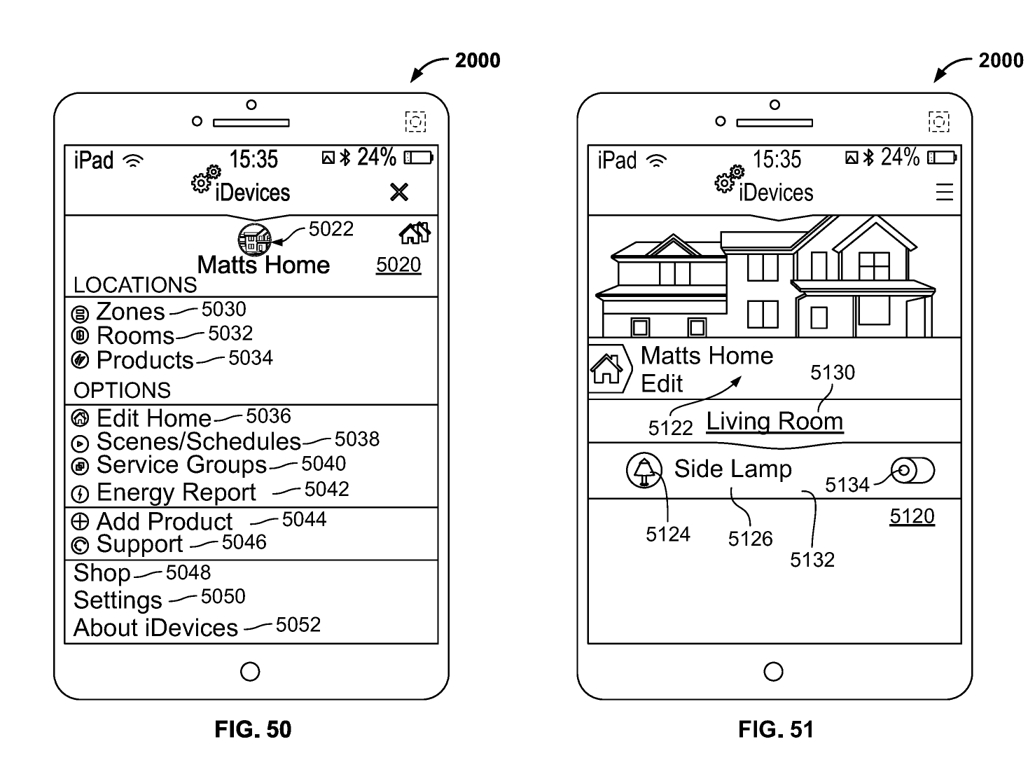

FIG. 50 shows the mobile computing device 2000 displaying a view 5020 that may be displayed if the user chooses to start the product. The view 5020 may include a “thumbnail” representation 5022 of the customized icon for the user's home. In some embodiments, the thumbnail representation may be based at least in part on the second cropped version of the photograph of the home. The view 5020 may further include a plurality of graphical tools, e.g., graphical tools 5030-5052. One of the graphical tools, e.g., graphical tool 5036, may be activated by a user to indicate a request to edit.

FIG. 51 shows the mobile computing device 2000 displaying a view 5120 that may be displayed if the user chooses to edit. The view 5120 may include a “full size” representation 5122 of the customized icon for the user's home. In some embodiments, the “full size” representation may be based at least in part on the first cropped version of the photograph of the user's home. The view 5120 may further include a thumbnail representation 5124 of the custom icon for the product having the name side lamp. In some embodiments, the thumbnail representation 5124 may be based at least in part on the second cropped version of the photograph of the side lamp. The view 5120 may further include the name of such product, e.g., “side lamp” 5126, and a plurality of graphical tools, e.g., graphical tools 5130-5134. One of the graphical tools, e.g., graphical tool 5130, may include the name of a room, e.g., living room, and may be activated by a user to indicate a request to edit in regard to such room. (In some embodiments, activation of the graphical tool 5130 may instruct the user interface to navigate to a view that allows the user to edit in regard to such room.) One of the graphical tools, e.g., graphical tool 5132, may include the thumbnail representation 5124 of the custom icon for the product having the name side lamp (and/or the name of such product, e.g., “side lamp”) and may be activated by a user to indicate a request to edit in regard to such product. In some embodiments, activation of the graphical tool 5132 may instruct the user interface to navigate to a view that allows the user to edit in regard to such product. One of the graphical tools, e.g., graphical tool 5134, may be activated by a user to control (e.g., an on/off state of) such product.

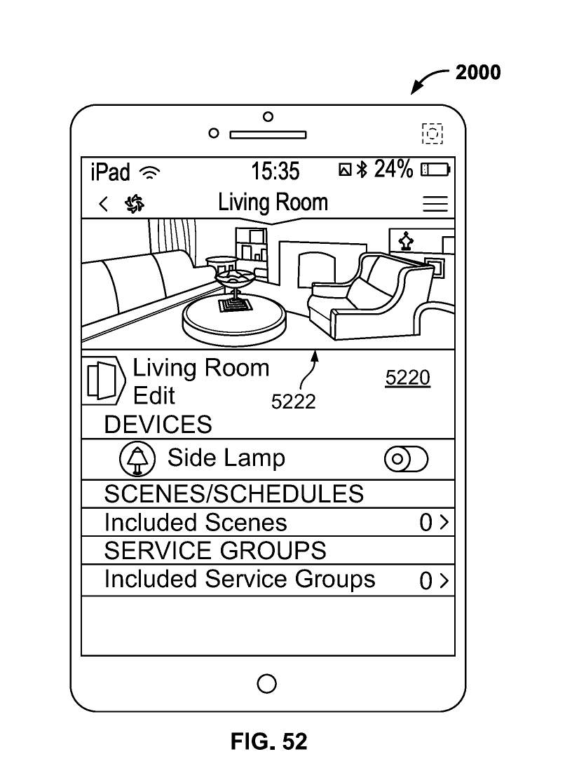

FIG. 52 shows the mobile computing device 2000 displaying a view 5220 that may be displayed if the user chooses to edit in regard to the living room. The view 5220 may include a “full size” representation 5222 of the customized icon for the living room. In some embodiments, the “full size” representation may be based at least in part on the first cropped version of the photograph of the living room.

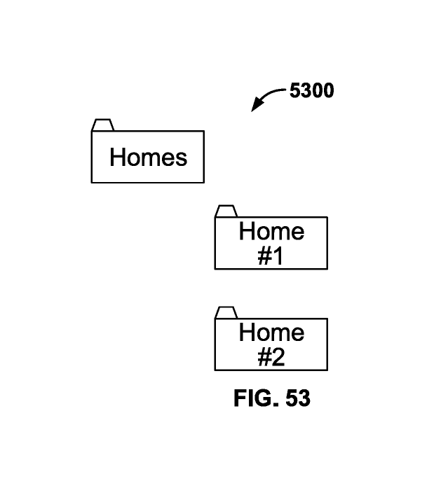

FIGS. 53-56 are schematic diagrams that collectively show a structure 5300 that may be used to store custom icons defined by, or otherwise associated with, a user or other entity, in accordance with some embodiments. In some embodiments, a user or other entity may choose where the structure is to be stored. In some embodiments, the structure may be stored locally on the computing device. In some embodiments, the structure may be stored in iCloud® and/or another online location or service. In some embodiments, the structure 5300 may be implemented as an Apple® UI document class.

Referring to FIG. 53, in accordance with some embodiments, the structure 5300 includes a folder for each home or building (or other type of site associated with the user or other entity). In the illustrated embodiment, the user or other entity is associated with two homes. The two homes may be named Home #1 and Home #2, respectively. Each folder may have the same name as the home associated therewith.

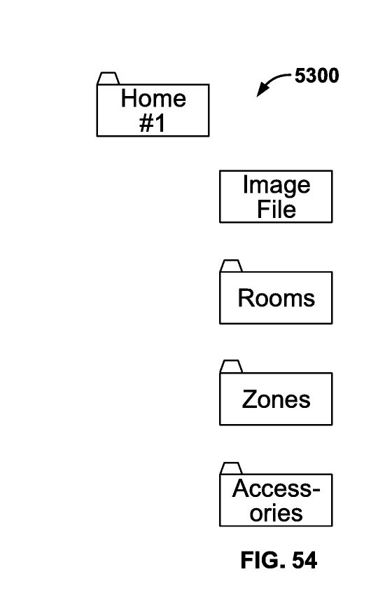

FIG. 54 is a schematic diagram showing contents of the folder for Home #1.

Referring to FIG. 54, the folder for Home #1, as with the folder for each of the other homes (or other types of sites), includes a folder for rooms, a folder for zones, and a folder for accessories. The folder for rooms may be named Rooms. The folder for zones may be named Zones. The folder for accessories may be named Accessories.

The folder for a home further includes an image file, if a custom icon has been defined for that home. The folder for Home #1 includes an image file. Thus, a custom icon has been defined for Home #1.

In some embodiments, the image file is an hkp file and/or a custom class. In some embodiments, the image file is a HomeKit® (by Apple®) photo class and/or a UI document class. In some embodiments, the image file is named image.hkp.

In some embodiments, the image file includes two images (not shown). The first image may have a predetermined resolution. In some embodiments, the predetermined resolution may be 145 pixels×145 pixels. In some embodiments, the first image may be used in instances in which a thumbnail image is desired. As should be appreciated, in some embodiments, the first image may be used to store and/or may otherwise comprise the second cropped version that is used for a “thumbnail” representation. In some embodiments, a shape desired for a thumbnail image may be different from the shape of the first image. In some embodiments, an overlap mask may be used to produce the desired shape, e.g., a circle.

The second image in the image file may not have a fixed resolution. However, it may have a fixed aspect ratio. In some embodiments, the second image may have a resolution of 640 pixels×300 pixels or 320 pixels×150 pixels. In some embodiments, the resolution of the second image is based at least in part on a size of a screen used by the user. In some embodiments, the resolution is selected to be the full size of such screen. As should be appreciated, in some embodiments, the second image may be used to store and/or may otherwise comprise the first cropped version that is used for a “full size” representation.

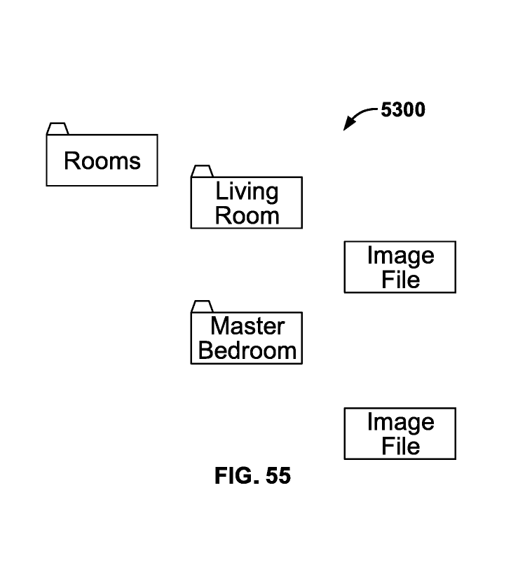

Referring to FIG. 55, the Rooms folder may include a folder for each room in the home or other site. Each folder may have the same name as the room associated therewith. In the illustrated embodiment, the Rooms folder includes a folder named Living Room and a folder named Master Bedroom. Thus, the home or other site may have a living room and a master bedroom.

The folder for a room includes an image file, if a custom icon has been defined for that room. The image file may have a format that is the same as or similar to the format of the image file described above for the home.

In the illustrated embodiment, the folder for the living room includes an image file. Thus, a custom icon has been defined for the living room. The folder for the master bedroom also includes an image file. Thus, a custom icon has also been defined for the living room.

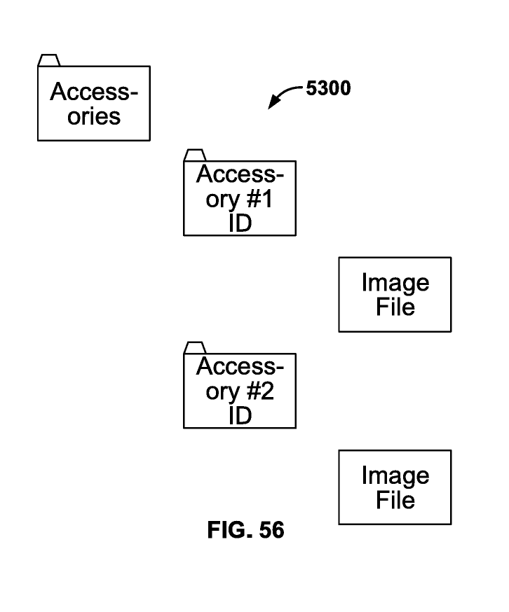

Referring to FIG. 56, the Accessories folder may include a folder for each accessory in the home or other site.

In accordance with some embodiments, accessories are devices that are to be controlled (directly and/or indirectly).

In the illustrated embodiment, the Accessories folder includes a folder for a first accessory and a folder for a second accessory. Each folder may have unique identifier. In the illustrated embodiment, the folder for the first accessory is named Accessory #1 ID. The folder for the second accessory is named Accessory #2 ID.

In some embodiments, the unique identifier may be generated using a hash function. In some embodiments, the unique identifier may be based at least in part on a serial number of an accessory, a model number of an accessory and/or a name of a manufacturer of the accessory. In some embodiments, the unique identifier is generated using a hash function based on the serial number of the accessory, the model number of the accessory and the name of the manufacturer of the accessory.

If a custom icon has been defined for an accessory, the folder for that accessory includes an image file. Such image file may have a format that is similar to the format of the image file described above for the home.

In the illustrated embodiment, custom icons have been defined for the first accessory and the second accessory. Consequently, the folder for the first accessory and the folder for the second accessory each include an image file.

The folder for an accessory includes an image file, if a custom icon has been defined for that accessory. The image file may have a format that is the same as or similar to the format of the image file described above for the home.

In the illustrated embodiment, the folder for the first accessory includes an image file. Thus, a custom icon has been defined for the first accessory. The folder for the second accessory also includes an image file. Thus, a custom icon has also been defined for the second accessory.

In some embodiments, a computing device, e.g., computing device 2000, may need to know (i.e., may need information as to) whether a custom icon has been generated for a home (or other site), a room, a zone and/or an accessory, in order to generate a view desired for a particular user or entity. In some embodiments, a computing device, e.g., computing device 2000, may obtain that information, at least in part, from the structure 5300. That is, a computing device may determine whether a custom icon has been defined for a home (or other site), a room, a zone or accessory based at least in part on whether the folder for the home (or other site), the room, the zone or the accessory, respectively, has an image file. If the folder for the home (or other site), the room, the zone or the accessory has an image file, the computing device may determine that a custom icon has been defined for the home (or other site), the room, the zone or the accessory, respectively. If the folder for the home (or other site), the room, the zone or the accessory does not have an image file, the computing device may determine that a custom icon has not been defined for the home (or other site), the room, the zone or the accessory, respectively.

In some embodiments, the following method may be used. In some embodiments, the method, or one or more portions thereof, (and/or any other method disclosed herein), may be performed by one or more computing devices, e.g., computing devices 1818₁-1818ₚ, 2000, and/or other device(s) disclosed herein.

In some embodiments, the method, or one or more portions thereof, may be used in generating a view to be displayed to a user or other entity. In some embodiments, the view may be a view in a user interface configured for use in control, by a computing device, of devices separate from the computing device. In some embodiments, the view may be similar to one or more of the views disclosed herein.

The method is not limited to the order presented. Rather, embodiments of the method may be performed in any order that is practicable. For that matter, unless stated otherwise, any method disclosed herein may be performed in any order that is practicable.

In some embodiments, one or more portions of the method may be performed without one or more other portions of the method. In some embodiments, one or more portions of the method (and/or any other method disclosed herein) may be performed in combination with one or more other methods and/or portions thereof.

The method may include receiving information associated with a user or other entity. The information may be received from any source(s) having the information or portions thereof. In some embodiments, the information may include the name of each home (or other site) associated with the user or other entity, the name of each room in each home (or other site) and the name of each accessory in each room. In some embodiments, the information may also one or more groupings (e.g., zones) of one or more portions of the information. In some embodiments, the information may include information in the form of one or more HomeKit® objects. In some embodiments, the information may include the types of information shown in the structure 5300. In some embodiments, the latter information may be received in a structure that is the same as and/or similar to the structure 5300.

The method may further include determining, by a computing device, a view that is to be generated and displayed in a user interface configured for use in control of devices separate from the computing device displaying the view;

The method may further include identifying predetermined information associated with the view. Predetermined information may exist at any level or levels. Identification may occur at any level or levels in any manner or manners. Predetermined information at a low level may include one or more instructions that may be used in generating a view. Predetermined information at a high level may include information relating to “look and feel” of a view (e.g., color, shapes, arrangement), characters (numbers, letters, symbols) and/or words in a view, etc. Some embodiments may include a relatively large amount of predetermined information. Some embodiments may include a relatively small amount of predetermined information. As will be reiterated below, unless stated otherwise, information may include data, and/or any other type of information (including, for example, but not limited to, one or more instructions to be executed by a processor), and may be in any form, for example, but not limited to, analog information and/or digital information in serial and/or in parallel form.

The method may further include determining a name of a home (or other site), a room, a zone or a device that is associated with the user or other entity and to be included in the view.

The method may further include determining whether the user or other entity has specified custom icon information associated with the home, the room, the zone or the device. The custom icon information may define the custom icon, at least in part.

In some embodiments, this may be performed as described above with respect to structure 5300. That is, a computing device may determine whether a custom icon has been defined for the home (or other site), the room, the zone or the device based at least in part on whether the folder for the home (or other site), the room, the zone or the device, respectively, has an image file. If the folder for the home (or other site), the room, the zone or the device has an image file, the computing device may determine that a custom icon has been defined for the home (or other site), the room, the zone or the device, respectively. If the folder for the home (or other site), the room, the zone or the device does not have an image file, the computing device may determine that a custom icon has not been defined for the home (or other site), the room, the zone or the device, respectively.

The method may further include determining, by a computing device, that the user or other entity has specified custom icon information associated with the home or other site, the room, the zone or the device.

The method may further include generating, by a computing device, the view based at least in part on the predetermined information and the custom icon information specified by the user.

The method may further include displaying, by a computing device, the view in the user interface configured for use in control of devices separate from the computing device displaying the view, the displayed view including: (i) visually perceptible information based at least in part on the predetermined information associated with the view and (ii) visually perceptible information that is associated with: (a) a device to be controlled using said user interface or (b) a building, a location and/or a room in which said device is located or will be located, and based at least in part on the custom icon information specified by the user.

In some embodiments, the visually perceptible information is based at least in part on the custom icon information and an overlap mask.

In some embodiments, the custom icon information is associated with a device to be controlled and the view includes a graphical tool that may be activated by a user to indicate a request to control one or more aspect of the operation of the device.

The method may further include receiving an indication that the user has requested to control one or more aspect of the operation of the device.

The method may further include controlling one or more aspect of the operation of the device based at least in part on the request.

In some embodiments, the visually perceptible information that is based at least in part on the custom icon information is part of a graphical tool that may be activated by a user to indicate a request to navigate to a second view that is associated with the home (or other site), the room, the zone or the device associated with the custom icon. In some embodiments, the visually perceptible information that is based at least in part on the custom icon information may not actually be part of a graphical tool but rather may be overlaid a portion of the graphical tool. In some other embodiments, the visually perceptible information may not be included or overlaid the graphical tool but rather in a same row, in a same column, or otherwise in register in any manner, with the graphical tool, so as to indicate an association with the graphical tool.

The method may further include receiving an indication that the user has requested to navigate to a second view that is associated with the home (or other site), the room, the zone or the device associated with the custom icon.

The method may further include identifying predetermined information associated with the second view.

The method may further include generating the second view based at least in part on the predetermined information and the custom icon.

The method may further include displaying the second view. The displayed second view may include: (i) visually perceptible information based at least in part on the predetermined information and (ii) visually perceptible information based at least in part on the custom icon information.

In some embodiments, the visually perceptible information is based at least in part on the custom icon information and an overlap mask.

In some embodiments, the visually perceptible information that is based at least in part on the custom icon information and included in the second view is different from the visually perceptible information that is based at least in part on the custom icon and included in the first view.

In some embodiments, the custom icon information is associated with a device to be controlled and the second view includes a graphical tool that may be activated by a user to indicate a request to control one or more aspect of the operation of the device.

The method may further include receiving an indication that the user has requested to control one or more aspect of the operation of the device.

The method may further include controlling one or more aspect of the operation of the device based at least in part on the request.

In some embodiments, the following second embodiment of a method may be used.

In some embodiments, the second method embodiment, or one or more portions thereof, may be used in generating a view to be displayed to a user or other entity. In some embodiments, the view may be a view in a user interface configured for use in control, by a computing device, of devices separate from the computing device. In some embodiments, the view may be similar to one or more of the views disclosed herein.

In some embodiments, one or more portions of the second method may be performed without one or more other portions of the second method.

The second method embodiment may include receiving, in a computing device, information associated with a user or other entity. The information may be received from any source(s) having the information or portions thereof. In some embodiments, the information may include the name of each home (or other site) associated with the user or other entity, the name of each room in each home (or other site) and the name of each accessory in each room. In some embodiments, the information may also one or more groupings (e.g., zones) of one or more portions of the information. In some embodiments, the information may include information in the form of one or more HomeKit® objects. In some embodiments, the information may include the types of information shown in the structure 5300. In some embodiments, the latter information may be received in a structure that is the same as and/or similar to the structure 5300.

The second method embodiment may further include receiving, in a computing device, an indication that a user has chosen to define a custom icon associated with: (a) a device to be controlled using said user interface or (b) a building, a location and/or a room in which said device is located or will be located.

The second method embodiment may further include receiving, in a computing device, custom icon information from the user defining the custom icon, at least in part.

The second method embodiment may further include identifying, by a computing device, predetermined information associated with a view in a user interface configured for use in control of devices separate from the computing device identifying the predetermined information.

The second method embodiment may further include generating, by a computing device, the view.

The second method embodiment may further include, displaying, by a computing device, the view in the user interface configured for use in control of devices separate from the computing device displaying the view, the displayed view including: (i) visually perceptible information based at least in part on the predetermined information associated with the view and (ii) visually perceptible information that is associated with: (a) a device to be controlled using said user interface or (b) a building, a location and/or a room in which said device is located or will be located, and based at least in part on the custom icon information from the user.

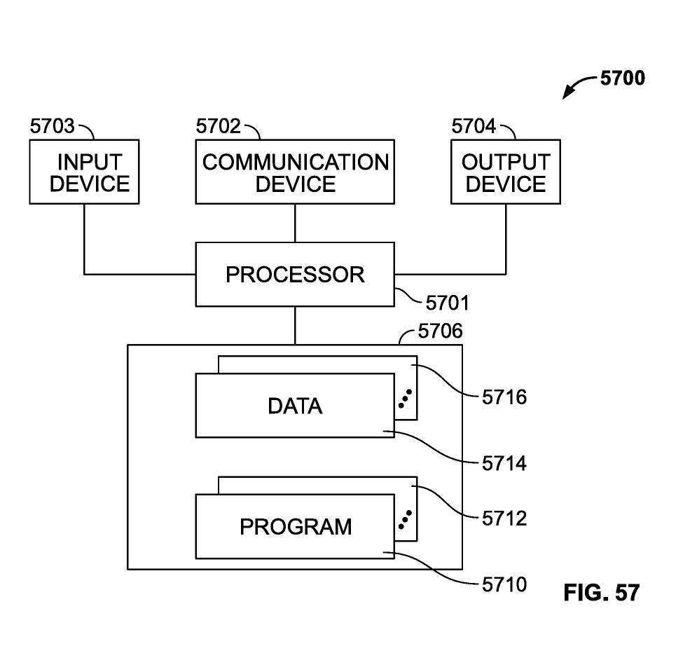

FIG. 57 is a block diagram of an architecture 5700 according to some embodiments. In some embodiments, one or more of the systems (or portion(s) thereof), apparatus (or portion(s) thereof) and/or devices (or portion(s) thereof) disclosed herein may have an architecture that is the same as and/or similar to one or more portions of the architecture 5700.

In some embodiments, one or more of the methods (or portion(s) thereof) disclosed herein may be performed by a system, apparatus and/or device having an architecture that is the same as or similar to the architecture 5700 (or portion(s) thereof).

The architecture may be implemented as a distributed architecture or a non-distributed architecture. A distributed architecture may be a completely distributed architecture or a partly distributed-partly non-distributed architecture.

Referring to FIG. 57, in accordance with some embodiments, the architecture 5700 includes a processor 5701 operatively coupled to a communication device 5702, an input device 5703, an output device 5704 and a storage device 5706, each of which may be distributed or non-distributed.

In some embodiments, the processor 5701 may execute processor-executable program code to provide one or more portions of the one or more disclosed herein and/or to carry out one or more portions of one or more embodiments of one or more methods disclosed herein.

In some embodiments, the processor 5701 may include one or more microprocessors, such as, for example, one or more “general-purpose” microprocessors, one or more special-purpose microprocessors and/or application specific integrated circuits (ASICS), or some combination thereof. In some embodiments, the processor 5701 may include one or more reduced instruction set (RISC) processors.

The communication device 5702 may be used to facilitate communication with other devices and/or systems. In some embodiments, communication device 5702 may be configured with hardware suitable to physically interface with one or more external devices and/or network connections. For example, communication device 5702 may comprise an Ethernet connection to a local area network through which architecture 5700 may receive and transmit information over the Internet and/or one or more other network(s).

The input device 5703 may comprise, for example, one or more devices used to input data and/or other information, such as, for example: a keyboard, a keypad, track ball, touchpad, a mouse or other pointing device, a microphone, knob or a switch, an infra-red (IR) port, etc. The output device 5704 may comprise, for example, one or more devices used to output data and/or other information, such as, for example: an IR port, a display, a speaker, and/or a printer, etc.

In some embodiments, the input device 5703 and/or output device 5704 define a user interface, which may enable an operator to input data and/or other information and/or to view output data and/or other information.

The storage device 5706 may comprise, for example, one or more storage devices, such as, for example, magnetic storage devices (e.g., magnetic tape and hard disk drives), optical storage devices, and/or semiconductor memory devices such as Random Access Memory (RAM) devices and Read Only Memory (ROM) devices.

The storage device 5706 may store one or more programs 5710-5712 and/or other information for operation of the architecture 5700. In some embodiments, the one or more programs 5710-5712 include one or more instructions to be executed by the processor 5701 to provide one or more portions of one or more tasks and/or one or more portions of one or more methods disclosed herein. In some embodiments, the one or more programs 5710-5712 include one or more operating systems, database management systems, other applications, other information files, etc., for operation of the architecture 5700.

The storage device 5706 may store one or more databases and/or other information 5714-5716 for one or more programs. As used herein a “database” may refer to one or more related or unrelated databases. Data and/or other information may be stored in any form. In some embodiments, data and/or other information may be stored in raw, excerpted, summarized and/or analyzed form.

In some embodiments, the storage device 5706 may include one or more images or other types of icons chosen or otherwise specified by the user and not included or otherwise supplied with the one or more programs 5710-5712.

In some embodiments, the storage device 5706 may include predetermined information that may be used in generating predetermined portions of one or more views. In some embodiments, one or more portions of such predetermined information may be included in one or more of the one or more programs 5710-5712 to be executed by the processor 5701.

In some embodiments, the storage device 5706 may include names that may be suggested as a custom name. In some embodiments, one or more of such names may be included in one or more of the one or more programs 5710-5712 to be executed by the processor 5701.

In some embodiments, the storage device 5706 may include a default image or other type of icon for each name. In some embodiments, one or more of such icons may be included in one or more of the one or more programs 5710-5712 to be executed by the processor 5701.

In some embodiments, the storage device 5706 or one or more other portion(s) of the architecture 5700 may include a default image or other type of icon for a plurality of types of products or accessories that may be controlled. In some embodiments, one or more of the default images (or other type of icon) may be included in one or more of the one or more programs 5710-5712 to be executed by the processor 5701.

In some embodiments, the one or more programs 5710-5712 may include a mapping between default images and manufacturer/model numbers. In some embodiments, a user of a program may enter a name of a manufacturer and a model number for a particular product or accessory via a user interface and the program may determine a default image for the product or accessory based on the manufacturer/model number and the mapping between default images and manufacturer/model numbers. In some embodiments, a particular product or accessory may transmit information that indicates its manufacturer/model number to the program and the program may determine a default image for such product may be determined based on the manufacturer/model number and the mapping between default images and manufacturer/model numbers.

In some embodiments, the architecture 5700 may comprise (and/or be based at least in part on) an iOS operating system, an android operating system, and/or any other operating system and/or platform.

In at least some embodiments, one or more portions of one or more embodiments disclosed herein may be embodied in a method, an apparatus, a system, a computer program product, and/or a non-transitory machine-readable storage medium with instructions stored thereon. In at least some embodiments, a machine comprises a processor.

It should be understood that the features disclosed herein can be used in any combination or configuration, and is not limited to the particular combinations or configurations expressly specified or illustrated herein. Thus, in some or all embodiments, one or more of the features disclosed herein may optionally be used without one or more other feature disclosed herein. In some or all embodiments, each of the features disclosed herein may optionally be used without any one or more of the other features disclosed herein. In some or all embodiments, one or more of the features disclosed herein may optionally be used in combination with one or more other features that is/are disclosed (herein) independently of said one or more of the features. In some or all embodiments, each of the features disclosed (herein) may be used in combination with any one or more other feature that is disclosed herein. Thus, the presence or lack of a feature or combination of features disclosed herein does not prevent other embodiments from containing or not containing said feature or combination.

Unless stated otherwise, the term “represent” means “directly represent” and/or “indirectly represent.”

Unless stated otherwise, a graphical tool may include, but is not limited to, any type or types of graphical control elements.

Unless stated otherwise, a computing device is any type of device that includes at least one processor.

Unless stated otherwise, a mobile computing device includes, but is not limited to, any computing device that may be carried in one or two hands and/or worn.

Mobile computing devices that may be carried in one or two hands include, but are not limited to, laptop computers (full-size or any other size), e-readers or other tablet computers (any size), a smart phone (or other type of mobile phone), a digital camera, a media player, a mobile game console, a portable data assistant and any combination thereof.

Mobile computing devices that may be worn include, but are not limited to: (i) eyeglasses having a computing device, (ii) a head-mounted apparatus (headset, helmet or other head mounted apparatus) having a computing device, (iv) clothing having a computing device (v) any other computing device that may be worn on, in and/or supported by: (a) a portion of a body and/or (b) clothing.

Unless stated otherwise, a processor may comprise any type of processor. For example, a processor may be programmable or non-programmable, general purpose or special purpose, dedicated or non-dedicated, distributed or non-distributed, shared or not shared, and/or any combination thereof. A processor may include, but is not limited to, hardware, software (e.g., low-level language code, high-level language code, microcode), firmware, and/or any combination thereof. Hardware may include, but is not limited to off-the-shelf integrated circuits, custom integrated circuits and/or any combination thereof. In some embodiments, a processor comprises a microprocessor. Software may include, but is not limited to, instructions that are storable and/or stored on a computer readable medium, such as, for example, magnetic or optical disk, magnetic or optical tape, CD-ROM, DVD, RAM, EPROM, ROM or other semiconductor memory. A processor may employ continuous signals, periodically sampled signals, and/or any combination thereof. If a processor is distributed, two or more portions of the processor may communicate with one another through a communication link.

Unless stated otherwise, the term “processor” should be understood to include one processor or two or more cooperating processors.

Unless stated otherwise, the term “memory” should be understood to encompass a single memory or storage device or two or more memories or storage devices.

Unless stated otherwise, a processing system is any type of system that includes at least one processor.

Unless stated otherwise, a processing device is any type of device that includes at least one processor.

Unless stated otherwise, “code” may include, but is not limited to, instructions in a high-level language, low-level language, machine language and/or other type of language or combination thereof.

Unless stated otherwise, a program may include, but is not limited to, instructions in a high-level language, low-level language, machine language and/or other type of language or combination thereof.

Unless stated otherwise, an application is any type of program.

Unless stated otherwise, a “communication link” may comprise any type(s) of communication link(s), for example, but not limited to, wired links (e.g., conductors, fiber optic cables) or wireless links (e.g., acoustic links, radio links, microwave links, satellite links, infrared links or other electromagnetic links) or any combination thereof, each of which may be public and/or private, dedicated and/or shared. In some embodiments, a communication link may employ a protocol or combination of protocols including, for example, but not limited to the Internet Protocol.

Unless stated otherwise, information may include data and/or any other type of information (including, for example, but not limited to, one or more instructions to be executed by a processor), and may be in any form, for example, but not limited to, analog information and/or digital information in serial and/or in parallel form. Information may or may not be divided into blocks.

Unless stated otherwise, terms such as, for example, “in response to” and “based on” mean “in response (directly and/or indirectly) at least to” and “based (directly and/or indirectly) at least on”, respectively, so as not to preclude intermediates and being responsive to and/or based on, more than one thing.

Unless stated otherwise, terms such as, for example, “in response to” and “based on” mean “in response at least to” and “based at least on”, respectively, so as not to preclude being responsive to and/or based on, more than one thing.

Unless stated otherwise, terms such as, for example, “comprises,” “has,” “includes,” and all forms thereof, are considered open-ended, so as not to preclude additional elements and/or features. In addition, unless stated otherwise, terms such as, for example, “a,” “one,” “first,” are considered open-ended, and do not mean “only a,” “only one” and “only a first,” respectively. Moreover, unless stated otherwise, the term “first” does not, by itself, require that there also be a “second.”

As used herein, the phrase “A and/or B” means the following combinations: A but not B, B but not A, A and B. It should be recognized that the meaning of any phrase that includes the term “and/or” can be determined based on the above. For example, the phrase “A, B and/or C” means the following combinations: A but not B and not C, B but not A and not C, C but not A and not B, A and B but not C, A and C but not B, B and C but not A, A and B and C. Further combinations using and/or shall be similarly construed.

As may be recognized by those of ordinary skill in the pertinent art based on the teachings herein, numerous changes and modifications may be made to the above-described and other embodiments without departing from the spirit and/or scope of the invention. By way of example only, the disclosure contemplates, but is not limited to, embodiments having any one or more of the features (in any combination or combinations set forth in the above description). Accordingly, this detailed description of embodiments is to be taken in an illustrative as opposed to a limiting sense.

What is claimed is:

1. A non-transitory computer-readable medium having computer-readable instructions stored thereon that, if executed by a computer system, result in a method comprising:
displaying, on a user interface of the computer system, an image or icon representing (i) a device adapted to be controlled by the computer system that is separate from the device or (ii) a zone, location, area, building or room in which said device is located; and
substituting, for said at least one image or icon, an image or icon selected or created by a user.

2. The non-transitory computer-readable medium of claim 1, the method further comprising displaying, on the user interface, the user-selected or created image or icon to represent said device, zone, location, area, building or room.

3. The non-transitory computer-readable medium of claim 1, wherein the substituting step includes substituting an image received from a camera or imager operatively connected to the computer system.

4. The non-transitory computer-readable medium of claim 1, wherein the substituting step includes substituting an image or icon received from (1) the computer system or (2) a memory remote from said computer system.

5. The non-transitory computer-readable medium of claim 1, the method further comprising accepting, from the user interface, an instruction from a user to substitute, for said at least one image or icon, an image or icon selected or created by a user.

6. The non-transitory computer-readable medium of claim 1, wherein the user interface is one or more of a keyboard, a touchscreen or a voice input.

7. A method comprising:
displaying, on a user interface of a computer system, an image or icon representing a device adapted to be controlled by the computer system that is separate from the device, or a zone, location, area, building or room in which said device is located; and
substituting, for said at least one image or icon, an image or icon selected or created by a user.

8. The method of claim 7, further including displaying, on the user interface, the user-selected or created image or icon to represent said device, zone, location, area, building or room.

9. The method of claim 7, further including receiving an image from a camera or imager operatively connected to the computer system, and wherein the substituting step includes substituting said image from said camera or imager.

10. The method of claim 7, wherein the substituting step includes substituting an image or icon received from: (1) the computer system or (2) a memory remote from said computer system.

11. The method of claim 7, further including accepting, from the user interface, an instruction from a user to substitute, for said at least one image or icon, an image or icon selected or created by a user.

12. The method of claim 7, where the user interface is one or more of a keyboard, a touchscreen or a voice input.

13. Apparatus comprising:
a computer system configured to:
display, on a user interface, an image or icon representing a device adapted to be controlled by the computer system that is separate from the device, or a zone, location, area, building or room in which said device is located; and
substitute, for said at least one image or icon, an image or icon selected or created by a user.

14. The apparatus of claim 13, wherein the computer system is further configured to display, on the user interface, the user-selected or created image or icon to represent said device, zone, location, area, building or room.

15. The apparatus of claim 13, configured to substitute, for said at least one image or icon, an image or icon selected or created by a user, by substituting an image received from a camera or imager operatively connected to the computer system.

16. The apparatus of claim 13, configured to substitute, for said at least one image or icon, an image or icon selected or created by a user, by substituting an image or icon received from (1) the computer system or (2) a memory remote from said computer system.

17. The apparatus of claim 13, wherein the computer system is further configured to accept, from the user interface, an instruction from a user to substitute, for said at least one image or icon, an image or icon selected or created by a user.

18. The apparatus of claim 13, wherein the user interface is one or more of a keyboard, a touchscreen or a voice input.

19. A method comprising:
receiving, in a computing device, an indication that a user has chosen to define a custom icon associated with one or more of: (a) a device to be controlled that is separate from the computing device or (b) one or more of a zone, a building, a location or a room in which said device is located or will be located;
receiving, in a computing device, information from the user defining the custom icon, at least in part;
identifying, by a computing device, predetermined information associated with a view in a user interface configured for use in control of the device, which is separate from a computing device configured to display the view;
generating, by a computing device, the view; and
displaying, by the computing device configured to display the view, the view, which includes: (i) visually perceptible information based at least in part on the predetermined information and (ii) visually perceptible information that is associated with one or more of: (a) the device to be controlled or (b) one or more of the zone, building, location or room, and based at least in part on the information from the user.

20. The method of claim 19, wherein the view further includes a graphical tool that is activatable by a user to indicate a request to control one or more operational aspects of the device, the method further comprising receiving an indication that the user has activated the graphical tool.

21. The method of claim 20, further comprising controlling one or more operational aspects of the device based at least in part on the activation of the graphical tool.

22. The method of claim 19, wherein the view is a first view, and wherein the visually perceptible information that is based at least in part on the information from the user is part of a graphical tool that is activatable by a user to indicate a request to navigate to a second view that is different than the first view and associated with one or more of: (a) the device to be controlled or (b) one or more of the zone, building, location or room.

23. The method of claim 19, wherein the computing device that receives the indication is also the computing device that receives the information, the computing device that identifies the predetermined information, the computing device that generates the view and the computing device that displays the view.

24. A non-transitory computer-readable medium having computer-readable instructions stored thereon that, if executed by a computer system, result in a method comprising:
receiving, in a computing device, an indication that a user has chosen to define a custom icon associated with one or more of: (a) a device to be controlled that is separate from the computing device or (b) one or more of a zone, building, a location or a room in which said device is located or will be located;
receiving, in a computing device, information from the user defining the custom icon, at least in part;
identifying, by a computing device, predetermined information associated with a view in a user interface configured for use in control of the device, which is separate from a computing device configured to display the view;
generating, by a computing device, the view; and
displaying, by the computing device configured to display the view, the view, which includes: (i) visually perceptible information based at least in part on the predetermined information and (ii) visually perceptible information that is associated with one or more of: (a) the device to be controlled or (b) one or more of the zone, building, location or room, and based at least in part on the information from the user.

25. The non-transitory computer-readable medium of claim 24, wherein the view further includes a graphical tool that is activatable by a user to indicate a request to control one or more operational aspects of the device, the method further comprising receiving an indication that the user has activated the graphical tool.

26. The non-transitory computer-readable medium of claim 25, further comprising controlling one or more operational aspects of the device based at least in part on the activation of the graphical tool.

27. The non-transitory computer-readable medium of claim 24, wherein the view is a first view, and wherein the visually perceptible information that is based at least in part on the information from the user is part of a graphical tool that is activatable by a user to indicate a request to navigate to a second view that is different than the first view and associated with one or more of: (a) the device to be controlled or (b) one or more of the zone, building, location or room.

28. The non-transitory computer-readable medium of claim 24, wherein the computing device that receives the indication is also the computing device that receives the information, the computing device that identifies the predetermined information, the computing device that generates the view and the computing device that displays the view.

29. A method comprising:
receiving, in a computing device, information associated with a user or other entity;
determining, by a computing device, a view that is to be generated and displayed in a user interface configured for use in control of a device that is separate from a computing device configured to display the view;
identifying, by a computing device, predetermined information associated with the view;
determining, by a computing device based at least in part on the information associated with the user or other entity, that the user or other entity has specified custom icon information associated with one or more of the device or one or more of a zone, a building, a location or a room in which said device is located or will be located;
generating, by a computing device, the view; and
displaying, by the computing device configured to display the view, the view, which includes: (i) visually perceptible information based at least in part on the predetermined information and (ii) visually perceptible information that is associated with one or more of: (a) the device to be controlled or (b) one or more of the zone, the building, the location or the room, and based at least in part on the custom icon information specified by the user.

30. The method of claim 29, wherein the view further includes a graphical tool that is activatable by a user to indicate a request to control one or more operational aspects of the device, the method further comprising receiving an indication that the user has activated the graphical tool.

31. The method of claim 29, wherein the view is a first view, and wherein the visually perceptible information that is based at least in part on the information from the user is part of a graphical tool that is activatable by a user to indicate a request to navigate to a second view that is different than the first view and associated with one or more of: (a) the device to be controlled or (b) one or more of the zone, building, location or room.

32. The method of claim 29, wherein the information associated with a user or other entity includes a name of the: (a) the device to be controlled or (b) one or more of the zone, building, location or room; and
wherein the determining that the user or other entity has specified custom icon information associated comprises:
determining, based at least in part on the name, that the user or other entity has specified custom icon information associated with one or more of the: (a) the device to be controlled or (b) one or more of the zone, building, location or room.

33. The method of claim 29, wherein the computing device that receives the information is also the computing device that determines the view, the computing device that identifies the predetermined information, the computing device that determines that the user or other entity has specified custom icon information, the computing device that generates the view and the computing device that displays the view.

34. A non-transitory computer-readable medium having computer-readable instructions stored thereon that, if executed by a computer system, result in a method comprising:
receiving, in a computing device, information associated with a user or other entity;
determining, by a computing device, a view that is to be generated and displayed in a user interface configured for use in control of a device that is separate from a computing device configured to display the view;
identifying, by a computing device, predetermined information associated with the view;
determining, by a computing device based at least in part on the information associated with the user or other entity, that the user or other entity has specified custom icon information associated with one or more of (a) the device or (b) one or more of a zone, a building, a location or a room in which said device is located or will be located;
generating, by a computing device, the view; and
displaying, by the computing device configured to display the view, the view, which includes:
(i) visually perceptible information based at least in part on the predetermined information; and
(ii) visually perceptible information that is associated with one or more of:
(a) the device to be controlled; or
(b) one or more of the zone, the building, the location or the room, and based at least in part on the custom icon information specified by the user.

35. The non-transitory computer-readable medium of claim 34, wherein the view further includes a graphical tool that is activatable by a user to indicate a request to control one or more operational aspects of the device, the method further comprising receiving an indication that the user has activated the graphical tool.

36. The non-transitory computer-readable medium of claim 34, wherein the view is a first view, and wherein the visually perceptible information that is based at least in part on the information from the user is part of a graphical tool that is activatable by a user to indicate a request to navigate to a second view that is different than the first view and associated with one or more of: (a) the device to be controlled or (b) one or more of the zone, building, location or room.

37. The non-transitory computer-readable medium of claim 34, wherein the information associated with a user or other entity includes a name of the: (a) the device to be controlled or (b) one or more of the zone, building, location or room; and
wherein the determining that the user or other entity has specified custom icon information associated comprises:
determining, based at least in part on the name, that the user or other entity has specified custom icon information associated with one or more of the: (a) the device to be controlled or (b) one or more of the zone, building, location or room.

38. The non-transitory computer-readable medium of claim 34, wherein the computing device that receives the information is also the computing device that determines the view, the computing device that identifies the predetermined information, the computing device that determines that the user or other entity has specified custom icon information, the computing device that generates the view and the computing device that displays the view.
